(19) United States
(12) Patent Application Publication
(10) Pub. No.: US 2025/0118151 A1
(43) Pub. Date: Apr. 10, 2025

(54) METHOD AND SYSTEMS WITH CUSTOM DEFINED MARKETS IN PARIMUTUEL BETTING

(71) Applicant: 1/ST Technology LLC, Hunt Valley, MD (US)

(72) Inventor: Paul Williams, Hollywood, FL (US)

(21) Appl. No.: 18/378,082

(22) Filed: Oct. 9, 2023

(51) Int. Cl. G07F 17/32

(52) U.S. Cl. CPC G07F 17/3225; G07F 17/3258; G07F 17/3267; G07F 17/3288

(57) ABSTRACT

A method of operating a gaming system may include receiving a plurality of orders. The method may include determining to accept the plurality of orders based on a validation process. The method include determining parimutuel pools associated with the plurality of orders. The method may include updating the parimutuel pools based on the plurality of orders. The method may include recalculating parimutuel odds for sets of selections for the parimutuel pools based on the plurality of orders. The method may include closing at least one parimutuel pool of the parimutuel pools to new orders. The method may include determining final odds for a set of selections for the at least one parimutuel pool and transmitting fixed odds to a wagering platform server when the at least one parimutuel pool will be paid out using fixed odds, wherein the fixed odds are determined based on the determined final odds.

### FIELD OF THE DISCLOSURE

Implementations of the disclosure relate to enhancements in entertainment systems, providing enhanced functionality and technical improvements over existing computing systems.

### BACKGROUND

Parimutuel wagering on live horse races has existed for over 100 years. Parimutuel wagering is a form of gaming where winners split a pool of bets according to the proportion of winning bets each winner places on the winning selection of a plurality of selections in the pool. The following is an example of a payout determined parimutuelly. Take a $10,000 parimutuel pool (e.g., bettors placed bets that totaled $10,000 on different betting lines into the parimutuel pool) with a host commission of 20%. The host commission can be deducted from the parimutuel pool. For example, with a commission rate of 20% the calculation is: $10,000×0.20=$2000. This leaves a net amount of $8000 ($10,000−$2000=$8000) for determining the payout odds. If one of the selections for the parimutuel pool received $1000 and this selection is a winning outcome in the parimutuel pool, the parimutuel payout for this selection would be 7:1 (or $8 for every dollar wagered—this payout includes the $1 wagered plus an additional $7 profit). If a player bets $10 on the winning selection associated with the $1000, the player would receive a parimutuel payout of $80 or 1 percent of the $8,000 pot (the net pool amount after the host commission).

Recently, new approaches to parimutuel wagering have been developed using historical horse races. This is important because some jurisdictions permit parimutuel wagering games while restricting other typical types of gambling games (e.g., traditional casino games such as slot machines or table games and fixed odds sports betting). Thus, to keep players entertained, there is a continual need to create new and improved parimutuel wagering systems, especially in jurisdictions that limit the types of gambling that are available to players.

### BRIEF SUMMARY

In some aspects, the techniques described herein relate to a method of operating a gaming system, including: receiving a plurality of orders, wherein different orders of the plurality of orders are made by different players; determining to accept the plurality of orders based on a validation process; determining parimutuel pools associated with the plurality of orders; updating the parimutuel pools based on the plurality of orders; recalculating parimutuel odds for sets of selections for the parimutuel pools based on the plurality of orders; closing at least one parimutuel pool of the parimutuel pools to new orders; determining final odds for a set of selections for the at least one parimutuel pool; determining whether the at least one parimutuel pool will be paid out parimutuelly or using fixed odds; transmitting fixed odds to a wagering platform server when the at least one parimutuel pool will be paid out using fixed odds, wherein the fixed odds are determined based on the determined final odds; determining results of a market for at least one parimutuel pool; determining winning orders for the at least one parimutuel pool based on the determined results of the market for the at least one parimutuel pool; and transmitting, to the wagering platform server, outcomes based on the results of the market for the at least one parimutuel pool.

In some aspects, the techniques described herein relate to a method, further including determining equal payout amounts for at least two orders of the plurality of orders, wherein the at least two orders are for a same market, the at least two orders are associated with a same wager value, the at least two orders are sent from a wagering platform server, and the at least two orders originated from a same state.

In some aspects, the techniques described herein relate to a method, further including determining different payout amounts for at least two orders of the plurality of orders, wherein the at least two orders are for a same market, the at least two orders are associated with a same wager value, and the at least two orders are sent from different wagering platform servers.

In some aspects, the techniques described herein relate to a method, further including determining different payout amounts for at least two orders of the plurality of orders, wherein the at least two orders are for a same market, the at least two orders are associated with a same wager value, and the at least two orders originated from different states.

In some aspects, the techniques described herein relate to a method, wherein at least two orders of the plurality of orders are associated with one parimutuel pool of the determined parimutuel pools, wherein the at least two orders of the plurality of orders originated from different states, wherein funds for wager values and bets resulting from the at least two orders are kept with respective wagering platform servers that sent the at least two orders.

In some aspects, the techniques described herein relate to a method, wherein the determined final odds for the set of selections for the at least one parimutuel pool are based on orders that originate from a plurality of different states, wherein the determined final odds are calculated independent of receiving funds for wager values and bets resulting from orders for the at least one parimutuel pool.

In some aspects, the techniques described herein relate to a method, wherein the at least one parimutuel pool is started with an initial seed value that is not derived from orders.

In some aspects, the techniques described herein relate to a method, further including: determining that another parimutuel pool of the parimutuel pools contains no winning orders; and submitting new orders for a new market, wherein at least some wager values for orders from the another parimutuel pool that contained no winning orders are added to a new parimutuel pool for the new market.

In some aspects, the techniques described herein relate to a method, further including: returning funds associated with orders from the another parimutuel pool based on determining that new parimutuel pool for the new market contained no winning order.

In some aspects, the techniques described herein relate to a method, wherein at least one of the orders from the plurality of orders is for an in running market.

In some aspects, the techniques described herein relate to a method, wherein at least one of the orders from the plurality of orders is for a market including any one of: a pre-game market, a future market, and a proposition market.

In some aspects, the techniques described herein relate to a method, wherein at least one of the plurality of orders is for a custom parlay market.

In some aspects, the techniques described herein relate to a method, wherein available selections for the custom parlay market are based on a template of predetermined selections that players use to request orders for the custom parlay market.

In some aspects, the techniques described herein relate to a method, further including determining available templates of predetermined selections for custom parlay markets to offer players based on real time market data on an in running competition.

In some aspects, the techniques described herein relate to a method, further including excluding at least one template of predetermined selections for a custom parlay market from being offered to players for an in running competition based on determining that at least one selection in the at least one template is not available for the in running competition from the real time market data.

In some aspects, the techniques described herein relate to a method, wherein transmitting the fixed odds to the wagering platform server causes the orders for at least parimutuel pool to be placed as fixed odds bets at the at least one wagering platform server using the transmitted fixed odds.

In some aspects, the techniques described herein relate to a method, further including receiving closed market information from the wagering platform server.

In some aspects, the techniques described herein relate to a method, further including closing a plurality of parimutuel pools based on receiving closed market information for one market, wherein the plurality of parimutuel pools include markets that include the one market.

In some aspects, the techniques described herein relate to a parimutuel system including: receive, from a wagering platform server, a plurality of orders at bet/order validation system, wherein different orders of the plurality of orders are made by different players; determine, at the bet/order validation system, to accept the plurality of orders based on a validation process; determine, at a pool total system, parimutuel pools associated with the plurality or orders; update, at the pool total system, the parimutuel pools based on the plurality of orders; recalculate, at the pool total system, parimutuel odds for sets of selections for the parimutuel pools based on the plurality of orders; close, using a parimutuel market management system, at least one parimutuel pool of the parimutuel pools to new orders; determine, at the pool total system, final odds for the sets of selections for the at least one parimutuel pool; determine, at the pool total system, whether the at least one parimutuel pool will be paid out parimutuelly or using fixed odds; transmit, from the pool total system to the wagering platform server, fixed odds when the at least one parimutuel pool will be paid out using fixed odds, wherein the fixed odds are determined based on the determined final odds; receive, at a pricing system, results of a market for the at least one parimutuel pool; determine, at the pricing system, winning orders for the at least one parimutuel pool based on the results of the market for the at least one parimutuel pool; and transmitting, from the pricing system to the wagering platform server, outcomes based on the results of the market for the at least one parimutuel pool.

In some aspects, the techniques described herein relate to a method of operating a gaming system, including: receiving a plurality of requests for bets for parlay markets; determining to accept the plurality of requests for bets based on a validation process, wherein the plurality of requests for bets become a plurality of bets; determining parimutuel pools associated with the plurality of bets; updating the parimutuel pools based on the plurality of bets; recalculating parimutuel odds for sets of selections for the parimutuel pools based on the plurality of bets, wherein the selections in the sets of selections are based on at least two markets; closing at least one parimutuel pool of the parimutuel pools to new bets; determining final odds for a set of selections for the at least one parimutuel pool; determining results of a parlay market for at least one parimutuel pool; determining winning bets for the at least one parimutuel pool based on the determined results of the parlay market for the at least one parimutuel pool; and transmitting, to a wagering platform server, outcomes based on the results of the parlay market for the at least one parimutuel pool.

### BRIEF DESCRIPTION OF THE FIGURES

FIG. 1A is a block diagram illustrating a parimutuel sports system, according to some implementations of the present disclosure.

FIG. 1B is a block diagram illustrating possible bet flows in a parimutuel sports system, according to some implementations of the present disclosure.

FIG. 2 is a block diagram illustrating a parimutuel sports system, according to some implementations of the present disclosure.

FIG. 3A is a flowchart illustrating a method of operating a parimutuel sports system, according to some implementations of the present disclosure.

FIG. 3B is a flowchart extending from FIG. 3A and further illustrating the method of operating a parimutuel sports system, according to some implementations of the present disclosure.

FIG. 4 illustrates communications and processes between different devices and/or systems of a parimutuel sports system for managing markets according to some implementations of the present disclosure.

FIG. 5 illustrates communications and processes between different devices and/or systems of a parimutuel sports system for creating markets in the parimutuel sports system according to some implementations of the present disclosure.

FIG. 6 illustrates communications and processes between different devices and/or systems of a parimutuel sports system for providing player terminals with access to market information according to some implementations of the present disclosure.

FIG. 7 illustrates communications and processes between different devices and/or systems of a parimutuel sports system for placing bets/selections on markets according to some implementations of the present disclosure.

FIG. 8 illustrates communications and processes between different devices and/or systems of a parimutuel sports system for cancelling placed bets/selections, standing orders on markets according to some implementations of the present disclosure.

FIG. 9A illustrates communications and processes between different devices and/or systems of a parimutuel sports system for closing parimutuel pools according to some implementations of the present disclosure.

FIG. 9B illustrates communications and processes between different devices and/or systems of a parimutuel sports system for resolving markets and determining bets or orders according to some implementations of the present disclosure.

FIG. 10 illustrates examples of custom parimutuel parlay bets that can be used with a parimutuel sports system according to some implementations of the present disclosure.

FIG. 11 illustrates additional examples of custom parimutuel parlay bets that can be used with a parimutuel sports system according to some implementations of the present disclosure.

### DETAILED DESCRIPTION

The systems and methods described herein provide a new form of gaming that combines sports wagering with parimutuel gaming systems. The systems and methods described herein also provide a new form of gaming that enables custom parimutuel wagering on competitions. The systems and methods described herein also provide a new way for wagering platforms to determine fix odds for markets using parimutuel gaming systems. These improvements provide players new forms of entertainment that were not previously available.

Traditionally, sports wagering uses fixed odds betting where individuals place bets on the outcome of a competition, such as sports matches (e.g., the outcome of a football game, the outcome of a baseball game, the outcome of a soccer match, etc.) at predetermined or fixed odds. In the course of normal operations, fixed odds bets are priced and placed at the time the customer requests it. Competition is used herein to describe a game or match that is occurring or will occur. A competition may include, but is not limited to, American Football, Aussie Rules Football, Baseball, Basketball, Boxing, Cornhole, Cricket, Cycling, Darts, E-Sports, F1, Golf, Handball, Ice Hockey, Horse Racing, Lacrosse, MMA (Mixed Martial Arts), Motor Sports, Pickleball, Rugby, Snooker, Squash, Soccer, Table Tennis, Tennis, Volleyball, etc. In fixed-odds betting, the odds are fixed and predetermined at the time of placing the bet (e.g., the player placing the bet knows the odds of winning the bet). The odds reflect the likelihood of a particular outcome occurring (e.g., the odds of the team A beating team B in a football game). If the bettor's prediction is correct, they receive a payout based on the predetermined fixed odds. This means that a player's potential winnings are known at the time of placing their bet, regardless of any changes in the odds leading up to the competition. In fixed-odds betting, a sportsbook offering the bets determines the odds for bets and funds the payouts on the bets. Thus, the sportsbook takes on the payout risk for bets that are offered. However, determining the odds for bets can be difficult and the process is inexact. Sportsbooks may use a few individuals or computer systems to determine odds for bets using historical data. In order to lower a sportsbooks' risk on large payouts, a sportsbook may limit the types of bets that are available and size of player's bets, which helps the sportsbook avoid large and risky payouts relative to the money it receives on losing bets.

Parimutuel wagering is another type of wagering. Parimutuel bets are placed at the time the customer requests them, but final pricing for the bets is applied when the markets for the bets are resolved. Traditionally, parimutuel wagering is used to determine payouts in limited types of competitions, such as horse racing and dog racing. Parimutuel wagering is a form of betting in which bets of a particular type can be placed together in a parimutuel pool. The host of a parimutuel wager system generally takes out or deducts certain percentages of a bet, such as for a house-take or host commission. The host adds the remainder of the bet to a particular pool or parimutuel pool. As noted above, payout odds for parimutuel wagers are calculated by sharing the pool among all winning bets. The house or host's financial risk is low because the pool is funded by player bets and generally not by the house or host. The low risk to the house or host enables bets and potential payouts to be larger than in a fixed-odds betting system. Parimutuel betting is different from fixed-odds betting because in parimutuel betting, parimutuel odds on selections in parimutuel pools will change as new wagers are added to the parimutuel pools and the payout odds for parimutuel bets are not determined until the parimutuel pools are closed (e.g., when the parimutuel pool does not take additional bets). Thus, players that place bets won't know the payout odds of their bets until a parimutuel pool for their wager is closed. A benefit of parimutuel betting is that it relies on the wisdom of the crowd to price payout odds. The more people that bet into a parimutuel pool, the more accurate the parimutuel odds may become for the various selections in the parimutuel pool. For example, a popular selection in a parimutuel pool will result in more wagers for the popular selection than for a less popular selection. Correspondingly, payout odds and thus the payout for the popular selection will be lower than for the less popular selection with fewer wagers. The lower payout odds for the popular selection line in the parimutuel pool indicates, based on the wisdom of the crowd placing bets into the parimutuel pool, that the selection in a market is more likely to happen. The higher payout odds for the less popular selection in the parimutuel pool indicates, based on the wisdom of the crowd placing bets into the parimutuel pool, that the selection in the market is less likely to happen. Crowd sourcing data may result in more accurate data than data that is sourced and determined by a few individuals (as is done in fixed odds systems). Enabling use of the wisdom of crowds to price bets and applying such crowd sourced payout odds for a fixed odds wagering system would be beneficial, but heretofore, did not exist.

Fixed odds betting (and therefore sports wagering) is legal in some jurisdictions, but not legal in all jurisdictions. On the other hand, in some jurisdictions where fixed odds betting is not legal, parimutuel wagering may be permitted. In jurisdictions where parimutuel wagering is legal but fixed odds betting is not permitted, players are unable to place bets on competitions. Thus, it would be beneficial and provide players with additional gaming options if players were permitted to place bets on competitions using parimutuel wagering in jurisdictions that traditionally prohibited sports betting (e.g., because sport betting was based on fixed odds betting). It would also be beneficial and help sportsbooks reduce their risk by using parimutuel style wagering to help sportsbooks determine fixed odds using parimutuel sourced (or crowd sourced) odds for their sports bet offerings, but ultimately rely on fixed odds to comply with jurisdictional gaming regulations.

However, setting up a system to enable sports betting with a parimutuel wagering system is technically challenging. Heretofore, existing parimutuel systems were limited to providing parimutuel wagering on known competitions of horse racing and dog racing. Existing parimutuel wagering systems were constructed to handle bets on these competitions before the competition starts, not bets on live or in running competitions (e.g., while the horses raced around the track). Existing parimutuel systems were also constructed to handle a limited set of known markets (e.g., win, place, show, exacta, trifecta, exotic bets, etc.) for limited types of competitions (e.g., horse racing or dog racing) with limited selections for the markets. Because existing parimutuel systems were also limited to certain competitions (e.g., horse racing, dog racing) with limited types of markets, this meant that the parimutuel pools used to aggregate bets/selections were also limited.

Preexisting parimutuel wagering systems were not built to handle sports betting. The shear variety of different competitions (e.g., American Football, Aussie Rules Football, Baseball, Basketball, Boxing, Cornhole, Cricket, Cycling, Darts, E-Sports, F1, Golf, Handball, Ice Hockey, Horse Racing, Lacrosse, MMA (Mixed Martial Arts), Motor Sports, Rugby, Snooker, Soccer, Table Tennis, Tennis, Volleyball, etc.) means that a parimutuel system for sports betting must be configured to determine which of the massive amounts of new markets and associated selections that might be available from these competitions and are usable for parimutuel wagering. Further, to offer selections on markets for in running competitions, parimutuel wagering systems would need to obtain and process the market data in real time or near real time. Moreover, offering players the ability to bet on custom parlay bets and provide both a parimutuel and fixed odds environment for these custom bets in competitions further increases the computational complexity of a parimutuel system for sport betting because the number of selection permutations for markets can often be more than a human can process. Thus, a parimutuel system for sports betting would need to overcome numerous technological obstacles. The system would need to be able to gather enough potential markets to satisfy the outcome needs of players and the selections for parlay combinations would need to be determined and approved quickly enough that markets haven't expired and players would not perceive a lag in placing a bet (e.g., so that a market is not resolved before enough bets can be placed). Obtaining vast volumes of real-time or near real-time market (and selections) data, sorting and selecting such data, keeping such data update-to-date and accurate, and obtaining results for the market on in running competitions creates a computational challenge. The system would need to be able to evaluate bets/orders to determine whether they will be processed parimutuelly or processed using a fixed odds system. As will be discussed herein, various implementations of systems and methods discussed herein solve these challenging technical problems to enable pregame, in running, future, and proposition markets for sports bets that can be paid out parimutuelly or using fixed odds and enable crowd sourced determination of fixed odds for sportsbooks and other wagering platforms.

Markets, as used herein, describes outcomes in a competition that players can bet on. Examples of markets may include, but are not limited to, predicting the winning horse in a horse race; predicting the team that scores the next touchdown; predicting which team scores the next basket; predicting if the next pitch be a ball or strike. A market may be associated with a plurality of selections. A market may be associated with a few different selections or many different selections. For example, in a 12 horse race, the selections for a win market are the 12 individual horses. A market for the team that scores the next touchdown in a football game has two selections: selection 1 is team A scores the next touchdown and selection 2 is team B scores the next touchdown. A market for predicting the outcome of the next pitch in a baseball game can be associated with many selections, such as predicting that the next pitch will be a homerun, strike out, a fly out, etc. A player's bet on a market includes choosing one of the possible selections for the market. A player's bet on a market also includes the wager value. Examples of a bet may include, but are not limited to, a wager value of $5 that player A scores the next touchdown; a wager value of $1 that team B scores the next basket; a wager value of $0.50 that the next pitch will be a strike.

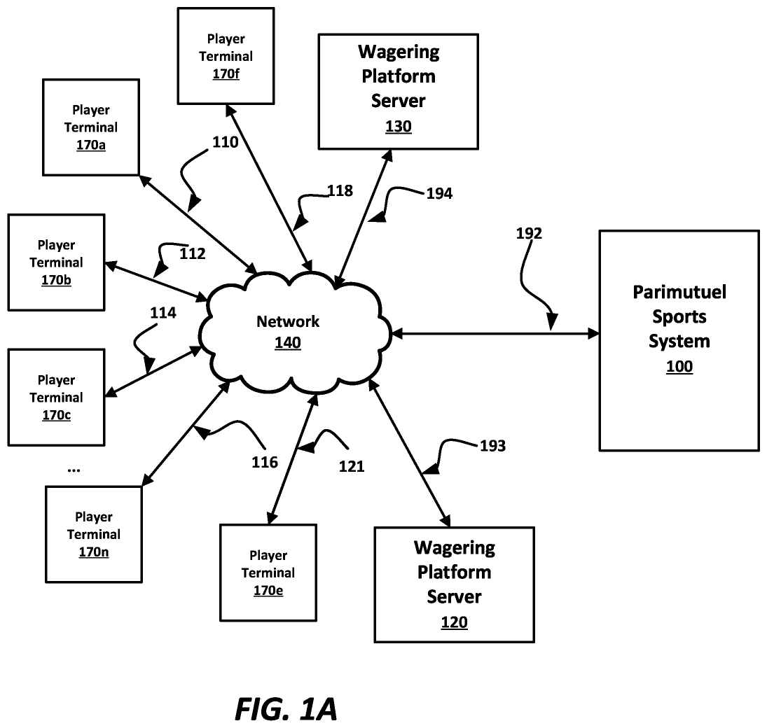

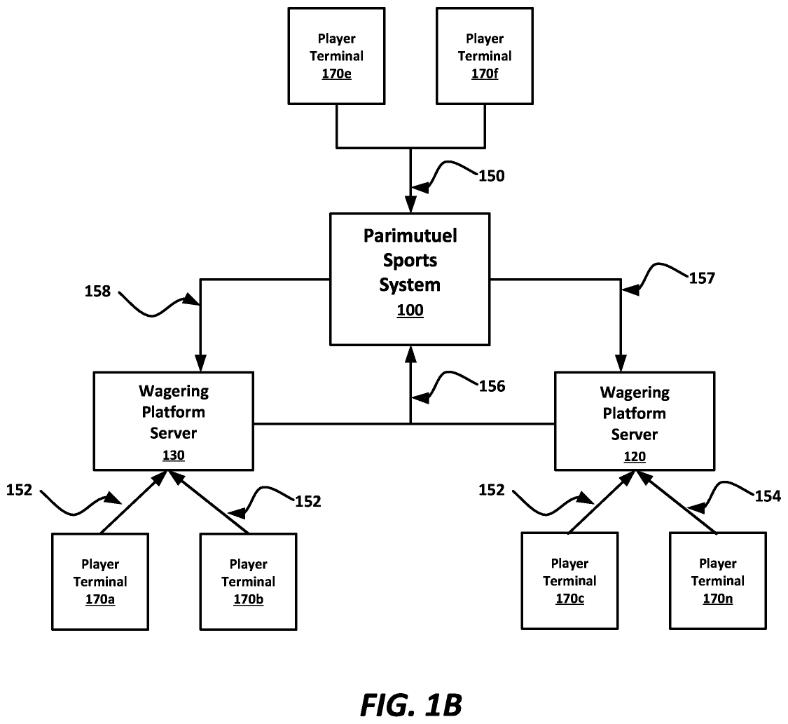

FIG. 1A is a block diagram that describes a parimutuel sports system, according to some implementations of the present disclosure. The parimutuel sports system may include parimutuel sports system 100 that includes one or more devices to handle various processing tasks. The devices may include one or more servers. The parimutuel sports system 100 may be in communication with player terminals and wagering platform servers. For example, the parimutuel sports system 100 may communicate with a plurality of player terminals, such as player terminal 170a, player terminal 170b, player terminal 170c, player terminal 170e, player terminal 170f, and player terminal 170n. It should be appreciated that the parimutuel sports system 100 may communicate with any number of player terminals or other suitable devices (e.g., electronic game machines) to implement the parimutuel sports system. The player terminals can be located any suitable location, such as, but not limited to, a casino, a gaming floor at horse track, a gaming floor at a sports wagering facility, a gas station, a player's home, etc. In some implementations, player terminals may communicate with the parimutuel sports system 100 via a network such as network 140. Parimutuel sports system 100 may be located in any suitable facility. In some implementations, the illustrated systems work together (along with other devices and systems) to provide a novel parimutuel sports system that can provide sports bets that can be paid out parimutuelly or using fixed odds, wherein the fixed odds are determined using crowd sourced parimutuel calculations.

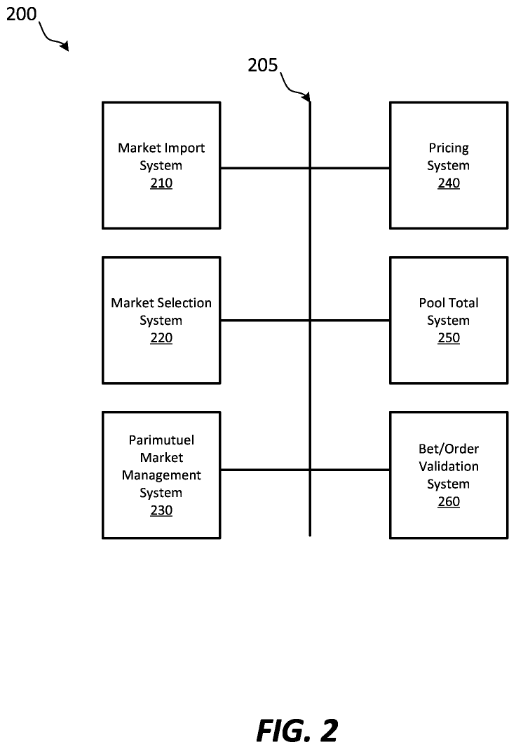

In some implementations, some portions of parimutuel sports system can be provided by parimutuel sports system 100. In some implementations, the parimutuel sports system 100 is configured to, among other things, obtain competition and market data, enable the creation of markets for competitions, create parimutuel pools for markets, determine payout odds for markets, take player bets, determine bet outcomes, and provide market resolutions and payouts to player terminals. Parimutuel sports system 100 can be one or more servers in a data center or a cloud-based computing system. Parimutuel sports system 100 can be a server, such as the parimutuel sports system with one or more subsystems described in connection with FIG. 2. In some implementations where parimutuel sports system 100 includes more than one server, the different servers may provide the same or similar functions. In some implementations where parimutuel sports system 100 includes more than one server, the different servers may provide different functions. Some of these different functions that can be separated into different servers are described in connection with FIG. 2. The parimutuel sports system 100 may comprise stand-alone computing devices. Various devices in parimutuel sports system 100 may include, but are not limited to, interface devices such as computer monitors, touch screens, buttons, etc. Various devices in parimutuel sports system 100 may include one or more processors, one or more types of non-transitory memory devices (e.g., RAM, ROM, etc.), network interface devices, etc. By way of non-limiting example, one or more devices in parimutuel sports system 100 may include one or more of a server, a desktop computer, a laptop computer, and/or other suitable computing platforms. The structure and functions of some implementations of the parimutuel sports system 100 will be described in greater detail herein.

In some implementations, parimutuel sports system 100 can be in communication with other devices or systems. For example, parimutuel sports system 100 can be in communication with other devices or systems through a suitable network, such as network 192. In some implementations, network 192 is at least one local area network (LAN). In some implementations, network 192 is a plurality of LANs. In some implementations, network 192 is at least one wide area network (WAN). In some implementations, network 192 is a plurality of WANs. In some implementations, network 192 is a combination of one or more LAN networks and one or more WAN networks. In some implementations, the LAN and/or WAN networks are hardwired networks (e.g., Ethernet™, fiber optic, etc.). In some implementations, one or more LAN and/or WAN networks can be a suitable wireless network (e.g., cellular, WiFi™, Bluetooth™, satellite, etc.). In some implementations, network 192 may be connected to a network 140. In some implementations, network 140 is one or more public networks (e.g., the Internet). In some implementations, network 140 is one or more private networks. In some implementations, network 140 is a combination of one or more public networks and one or more private networks.

In some implementations, parimutuel sports system 100 may communicate directly or indirectly with one or more player terminals (e.g., player terminal 170a-player terminal 170n) that provide access to sports wagering. A player terminal may include a game interface, which provides a way for players to interact with the player terminal. The game interface may provide an entertaining display to a player, enable a player to make or cancel bets/wagers, view their balance, obtain information on competitions, markets, odds for markets, etc. A player terminal may include one or more systems and functions to communicate with the parimutuel sports system 100. Communications from a player terminal to the parimutuel sports system 100 can be encrypted.

In some implementations, player terminals are user interface devices that may comprise stand-alone computing devices. In some implementations, player terminals can be client terminals in a client/server system (e.g., where parimutuel sports system 100 acts as the server). Player terminals can be used to accept player inputs for a game, such as competition and market choices, bets, player tracking cards, etc. Player terminals may include, but are not limited to, player interface devices such as computer monitors, touch screens, buttons, card and ticket readers, ticket printers, etc. In some implementations, player terminals may include or be in communication with one or more cashless wallet systems for accepting player funds that can be converted credits or chips for wagers. Player terminals may include one or more processors, one or more types of non-transitory memory devices (e.g., RAM, ROM, etc.), network interface devices, etc. By way of non-limiting example, given player terminals may include one or more of a server, a desktop computer, a laptop computer, a handheld computer, a tablet computing platform, a smartphone, a gaming console, and/or other computing platforms. Player terminals can be used to play one or more different games. It should be appreciated that in implementations where a player terminal is a mobile device (e.g., a laptop computer, a handheld computer, a tablet computing platform, a smartphone, etc.) and where regulations permit, such a mobile player terminal may permit a player to play one or more different games outside of a casino environment, such as at a player's home. In some implementations, a mobile player terminal may permit a player to play one or more different games anywhere regulations permit game play, sports wagering, or parimutuel based sports wagering.

The player terminals may use suitable networks to communicate with parimutuel sports system 100. For example, player terminal 170a may communicate with parimutuel sports system 100 through network 110 and network 140. Player terminal 170b may communicate with parimutuel sports system 100 through network 112 and network 140. Player terminal 170c may communicate with parimutuel sports system 100 through network 114 and network 140. Player terminal 170e may communicate with parimutuel sports system 100 through network 121 and network 140. Player terminal 170f may communicate with parimutuel sports system 100 through network 118 and network 140. Player terminal 170n may communicate with parimutuel sports system 100 through network 116 and network 140. In some implementations, player terminals communicate with wagering platform servers (e.g., wagering platform server 120 and wagering platform server 130), and the wagering platform servers pass on communications from player terminals to the parimutuel sports system 100. In some implementations, networks 110, 112, 114, 116, 118, and 121 can be examples of the same network. In some implementations, one or more of the networks 110, 112, 114, 116, 118, and 121 can be one or more different networks from each other. In some implementations, the suitable networks can be a LAN. In some implementations, the suitable networks can be a plurality of LANs. In some implementations, suitable networks can be at least one WAN. In some implementations, the suitable networks can be a plurality of WANs. In some implementations, the suitable networks can be a combination of one or more LAN networks and one or more WAN networks. In some implementations, the LAN and/or WAN networks are hardwired networks (e.g., Ethernet™, fiber optic, etc.). In some implementations, one or more LAN and/or WAN networks can be a suitable wireless network (e.g., cellular, WiFi™, Bluetooth™, satellite, etc.). The LAN and/or WAN networks can be a combination of hardwired networks and wireless networks.

In some implementations, some portions of the parimutuel sports system can be provided by one or more wagering platform servers (e.g., wagering platform server 120, wagering platform server 130, etc.). The parimutuel sports system may use any suitable number of wagering platform servers. In some implementations, wagering platform servers are provided and managed by operators separate from the parimutuel sports system. In some implementations, operators of the parimutuel sports system may own or manage wagering platform servers. Wagering platform servers can be configured to, among other things, provide real time or near real time competition data, market data for competitions, and market resolution data to parimutuel sports system 100. Wagering platform servers may accept determinations of fixed odds from parimutuel sports system 100 for one or more selections for one or more markets. Wagering platform servers may pass bets, orders for bets, or other suitable bet information to parimutuel sports system 100. Parimutuel sports system 100 may place bets where the bets will be paid out parimutuelly. Parimutuel sports system 100 may take information regarding orders for bets where the orders for bets will be paid out using fixed odds. Wagering platform servers may also take bets/orders from player terminals.

Wagering platform servers can be one or more servers in a data center or a cloud-based computing system. In some implementations where wagering platform servers includes more than one server, the different servers may provide the same or similar functions. In some implementations where wagering platform servers includes more than one server, the different servers may provide different functions. Wagering platform servers may comprise stand-alone computing devices. Wagering platform servers may include, but are not limited to, interface devices such as computer monitors, touch screens, buttons, etc. Wagering platform servers may include one or more processors, one or more types of non-transitory memory devices (e.g., RAM, ROM, etc.), network interface devices, etc. By way of non-limiting example, wagering platform servers may include one or more of a server, a desktop computer, a laptop computer, and/or other suitable computing platforms.

In some implementations, wagering platform servers (e.g., wagering platform server 120, wagering platform server 130, etc.) can be in communication with other devices or systems, including devices in the parimutuel sports system. For example, wagering platform server 120 can be in communication with other devices or systems through a suitable network, such as network 193. Wagering platform server 130 can be in communication with other devices or systems through a suitable network, such as network 194. Network 193 and network 194 can be at least one local area network (LAN). Network 193 and network 194 can be a plurality of LANs. Network 193 and network 194 can be at least one wide area network (WAN). Network 193 and network 194 can be a plurality of WANs. Network 193 and network 194 can be a combination of one or more LAN networks and one or more WAN networks. In some implementations, the LAN and/or WAN networks are hardwired networks (e.g., Ethernet™, fiber optic, etc.). In some implementations, one or more LAN and/or WAN networks can be a suitable wireless network (e.g., cellular, WiFi™, Bluetooth™, satellite, etc.). In some implementations, network 193 and network 194 may be connected to network 140.

FIG. 1B is a block diagram illustrating some possible flows of bets made in the parimutuel sports system 100, according to some implementations of the present disclosure. The parimutuel sports system may determine payouts using at least two different methods for sports bets. One method enables determining sports bet payouts using a parimutuel system. Another system provides determining sports bet payouts using fixed odds at a fixed odds wagering platform, where the fixed odds are determined in part based on parimutuelly determined odds. This modified fixed odds determination process enables the parimutuel sports system 100 to supply one or more a wagering platforms with fixed odds to reduce the wagering platforms' risk in determining the fixed odds. Parimutuel sports system 100 may use crowd sourced odds determined parimutuelly without placing bets from wagering platforms and in turn supply fixed odds back to the wagering platforms. This enables wagering platforms to use the supplied fixed odds to place bets, but still obtain the benefits of parimutuelly determined odds and comply with laws and regulations that may prohibits parimutuel wagering or prohibit sending bets across state lines.

As shown with bet flow arrow 150 in FIG. 1B, player terminal 170e and player terminal 170f may send requests for bets to parimutuel sports system 100. It should be appreciated that any number of player terminals may send requests for bets to the parimutuel sports system 100. These requests for bets may be for sports bets placed under a parimutuel wagering system, where payouts are determined parimutuelly. Player terminal 170e and player terminal 170f may be in jurisdictions that permit parimutuel wagering, but not permit fixed odds sports betting. Player terminal 170e and player terminal 170f may be in jurisdictions that permit fixed odds sports betting, but the players desired to place sports bets using parimutuel wagering to potentially obtain larger payouts than may be available in a fixed odds system. There may be other suitable reasons to place sports bets under a parimutuel system. Parimutuel sports system 100 may place bets from player terminal 170e and player terminal 170f, add wager values from the placed bets into appropriate parimutuel pools, and determine payouts for the bets using parimutuel payout odds. Parimutuel sports system 100 may provide any payouts for bets won to appropriate player terminals, such as player terminal 170e or player terminal 170f. In some implementations, player terminals may send requests for bets to a wagering platform server (e.g., wagering platform server 120, wagering platform server 130, etc.) and the wagering platform server communicates the requests for bets to parimutuel sports system 100. It should be appreciated that player terminals may send requests for bets to parimutuel sports system 100 through any suitable intermediary system as was previously noted.

Some requests for bets made by player terminals can be processed differently. In some implementations, an alternative process may include using parimutuel pools to determine fixed odds for markets and requests for bets on such markets will be paid out using fixed odds. For example, player terminals (e.g., player terminal 170a, player terminal 170b, player terminal 170c, and player terminal 170n) may be located in jurisdictions that permit fixed odds sports betting, but may not permit parimutuel wagering. In an alternative example, player terminals may be located in jurisdictions that permit fixed odds sports betting and permit parimutuel wagering, but the wagering platforms (e.g., wagering platform server 120 and wagering platform server 130) may desire to offer fixed odds sports bets where the payout odds are determined by players bets rather than by the wagering platform (e.g., parimutuelly). There may be other suitable reasons to determine fixed odds for sports bets at least partially using a parimutuel odds determination method.

Players may send requests for orders for bets (i.e., referred to herein as orders) to a wagering platform server (e.g., wagering platform server 120 or wagering platform server 130). Orders are distinct from bets. An order contains information for a bet, but a bet has not yet been placed. Orders are made at time a player requests them, then bets resulting from the orders are placed by a wagering platform server utilizing fixed odds pricing at the time a market for the order closes. For example, if the players' orders are to be paid out using fixed odds, the wagering platform server may hold the players' orders and may transmit information regarding the players' orders to parimutuel sports system 100 to be processed parimutuelly. In some implementations, the wagering platform server may hold funds for the wager values from the orders in escrow and not pass bets resulting from the orders to parimutuel sports system 100. In some implementations, bets resulting from orders are not placed before sending the order information to parimutuel sports system 100 to avoid sending bets across jurisdictional borders. In some implementations, the players' orders do not get placed as bets until the wagering platform server receives fixed odds for the players' orders from parimutuel sports system 100 (which may be determined by parimutuel sports system 100 after a market for the order is closed). When a wagering platform server obtains the fixed odds for the players' orders (e.g., after the market is closed, parimutuel sports system 100 determines the fixed odds, and parimutuel sports system 100 provides the fixed odds to the wagering platform server), the wagering platform server may convert the orders into placed bets (or reject the orders and refund the wager values if bets based on the orders cannot be placed). When funds for wager values are held in escrow, the funds may be deducted from player accounts. In some implementations, when funds are held in escrow, the funds cannot be used to fund other player bets unless the order is cancelled and the wager value is refunded.

A wagering platform server may send information for the received orders (including the selections and associated wager values) to parimutuel sports system 100 for processing. Parimutuel sports system 100 may store the information associated with such orders with appropriate parimutuel pools for such orders. For example, if an order included a selection of the next pitch will be a homerun and a wager value of $10, parimutuel sports system 100 may include a representation of the player's $10 wager value in a parimutuel pool associated with the next pitch market for the baseball competition. In some implementations, funds for wager value collected at a wagering platform server for orders are not sent to the parimutuel sports system 100. Rather, the funds for wager value collected at a wagering platform server for orders may remain at the wagering platform server while the parimutuel sports system 100 tracks the player's $10 wager value on the selection with the appropriate parimutuel pool. In some implementations, actual wager values collected at the wagering platform server for orders could be sent to the parimutuel sports system 100 for distribution. While parimutuel pools are open, parimutuel sports system 100 may keep the parimutuel odds for the parimutuel pools up to date as new wager values for selections from orders are added, removed, or otherwise associated with the parimutuel pools. At an appropriate time, such as after the parimutuel pools have been closed to additional player orders, the parimutuel sports system 100 may determine payout odds or final odds for the parimutuel pools associated with player orders (as well as for the other selections associated with the parimutuel pools). Parimutuel sports system 100 may then provide the wagering platform server with final odds to be used as fixed odds for the player orders. After receiving the fixed odds for the player orders, the wagering platform server may convert the players' orders into placed bets using the fixed odds provided by parimutuel sports system 100. It should be appreciated that in some implementations, players' orders can be converted to be placed with the wagering platform server at any suitable time. The wagering platform server may determine the results of the markets associated with the players' bets and calculate any player winnings based on the fixed odds determined through the parimutuel method. In some implementations, the parimutuel sports system 100 may determine the results of the markets associated with the players' bets and calculate any player winnings based on the fixed odds determined through the parimutuel method and provide this information to the wagering platform server. The wagering platform server may provide the players with any calculated winnings.

Bets and orders (also represented herein as bets/orders) can be sent from wagering platform servers to a parimutuel sports system 100 as individual bets or orders as they are received. In some implementations, bets/orders can be sent from wagering platform servers to a parimutuel sports system 100 in an aggregated form. For example, wagering platform server may accumulate bets/orders over a predetermined period of time and periodically transmit accumulated bets/orders to parimutuel sports system 100 for processing as discussed above. The periodic transmittal can be at some predetermined interval, such as sub second, every second, 10 seconds, every minute, or some other suitable interval. The accumulated bets/orders can be sent from the wagering platform server to parimutuel sports system 100 as a group of individual bets/orders. In some implementations, accumulated bets/orders can be aggregated and sent from the wagering platform server to parimutuel sports system 100. For example, wagering platform server may receive an order from player terminal 170a that included a selection of the next pitch will be a homerun and a wager value of $10 for a competition. The wagering platform server may also receive an order from player terminal 170b that included a selection of the next pitch will be a homerun and a wager value of $20 for the same competition. The wagering platform server may aggregate these orders and send them in an aggregated form to parimutuel sports system 100. In some implementations, the wagering platform server may send to parimutuel sports system 100 an order for a selection of the next pitch will be a homerun and a wager value of $30 (e.g., aggregating the two orders together). In some implementations, parimutuel sports system 100 is not aware that the received order comprises two separate orders. In such a situation, parimutuel sports system 100 may add the aggregated orders to the appropriate parimutuel pool and provide the final odds to the wagering platform server to use as the fixed odds. Once the wagering platform server receives the fixed odds, the wagering platform server may determine the payout amounts for player terminal 170a and player terminal 170b if the resulting bets from the orders are determined to be winning bets.

Using FIG. 1B to further illustrate the modified fixed odds determination method, player terminal 170a and player terminal 170b may submit orders on a market in a competition at wagering platform server 130 as shown by bet flow arrows 152. Wagering platform server 130 may take such orders from the player terminals and pass them (or information related the orders) to parimutuel sports system 100 as shown with bet flow arrow 156. Parimutuel sports system 100 may analyze the orders and place them into appropriate parimutuel pools. Likewise, player terminal 170c and player terminal 170n may submit orders on a market in a competition at wagering platform server 120 as shown by bet flow arrow 154. Wagering platform server 120 may take such orders from the player terminals and pass them (or the information associated with the orders) to parimutuel sports system 100 as shown with bet flow arrow 156. Parimutuel sports system 100 may analyze the orders and place them into appropriate parimutuel pools. As parimutuel sports system 100 receives orders from wagering platform servers, parimutuel sports system 100 may continually update the parimutuel odds for the parimutuel pools associated with such orders. At a suitable time, parimutuel sports system 100 may close the parimutuel pools to new orders and determine final odds for the parimutuel pools. For example, if the bets from player terminal 170a player terminal 170b, player terminal 170c, and player terminal 170n are in the same parimutuel pool, the parimutuel odds for the pool can be updated upon receiving the bets from the player terminals. If parimutuel sports system 100 determines that the parimutuel pool is closed to new orders, the parimutuel sports system 100 may determine final odds for the parimutuel pool. The parimutelly determined final odds can be used as the fixed odds. Parimutuel sports system 100 may transmit the fixed odds to the wagering platform servers. For example, parimutuel sports system 100 may transmit the fixed odds for the orders from player terminal 170a and player terminal 170b to wagering platform server 130 as shown by bet flow arrow 158. Similarly, parimutuel sports system 100 may transmit the fixed odds for orders from player terminal 170c and player terminal 170n to wagering platform server 120 as shown by bet flow arrow 157. In some implementations, after receiving the fixed odds from parimutuel sports system 100, the wagering platform servers 120 and wagering platform server 130 may convert the orders from the player terminals into placed bets based on the received fixed odds. The wagering platform servers can thereafter evaluate the bets for winning outcomes and calculate the payouts on any winning bets based on the received fixed odds. In some implementations, parimutuel sports system 100 can evaluate the bets for winning outcomes and calculate the payouts on any winning bets based on the received fixed odds and send the information to the wagering platform servers. Wagering platform servers can send results of the player bets to the player terminals and distribute any winnings to the player.

In the example noted above, orders from player terminal 170a, player terminal 170b, player terminal 170c, and player terminal 170n were described as being associated with the same parimutuel pool. Because these players are associated with different wagering platform servers, it should be appreciated that orders (or bets) different wagering platform servers can be comingled within the same parimutuel pool. This can be advantageous to increase the size of a parimutuel pool as well as creating a larger sample size (e.g., the crowd source effect) to determine the final odds for parimutuel pools.

In some implementations, separate parimutuel pools can be created for different wagering platform servers. For example, orders from player terminal 170a and player terminal 170b may be segregated into parimutuel pools created for wagering platform server 130 and orders from player terminal 170c and player terminal 170n may be segregated into parimutuel pools for wagering platform server 120. In some implementations, parimutuel pools may combine orders from wagering platform servers (e.g., wagering platform server 120 and wagering platform server 130) as well as bets slated to be resolved parimutuelly. For example, bets from player terminal 170e and player terminal 170f may be combined into the same parimutuel pools as the parimutuel pools for orders from wagering platform server 120 and wagering platform server 130 to determine fixed odds to return to wagering platform server 120 and wagering platform server 130 from a larger group of players. In one such scenario, bets that will be paid out parimutuelly can be later segregated to determine separate payout odds and exclude wager values from orders that will be paid out under fixed odds (e.g., to avoid parimutuel payouts that are not associated with wager values that can be distributed parimutuelly). As noted above, in some implementations, it may be advantageous to include as many bets and/or orders into a parimutuel pool so that the payout odds are determined by as many bettors as possible (e.g., using the wisdom of the crowd or crowdsourcing), which may provide a better final odds determination than a wagering platforms could determine on its own using the knowledge of a few individuals, historical data, and statistical methods or systems.

Wagering platform servers (e.g., wagering platform server 120 and wagering platform server 130) can also place send player requests for bets that will be evaluated parimutuelly, rather than sending orders that will be evaluated the modified fixed odds method discussed above. For example, a request for a bet from player terminal 170a may be placed as a bet at parimutuel sports system 100 and added to an appropriate parimutuel pool. Any winnings can be paid out parimutuelly, as with the bets from player terminal 170e and player terminal 170f. In some implementations, when a bet from player terminal 170a will be paid out parimutuelly, the bet is placed rather than being an held as an order. In some implementations, bets from wagering platform servers that will be evaluated and paid out parimutuelly can be comingled in parimutuel pools, such as with parimutuel pools associated with bets from player terminal 170e and player terminal 170f or bets from other wagering platform servers. The ability to comingle bets from different wagering platform servers may depend on legal and regulatory restrictions, such as whether the requests for bets originate from the same state or from different states.

In some scenarios, parimutuel sports system 100 may use a net settlement process to determine how to properly distribute funds between two or more wagering platform servers or other entities. The parimutuel sports system 100 may use the net settlement process when bets in the parimutuel pools are shared amongst the two or more wagering platforms or other entities. Parimutuel sports system 100 may determine settlement apportionment between the two or more wagering platform servers or other entities to the extent that the value of winning bets at one wagering platform server exceeds the value of bets initially collected at the other wagering platform servers or other entities. As a more specific example, assume player terminal 170a and player terminal 170b requested bets through wagering platform server 130 that total $70. The wagering platform server 130 requests that bets be placed at parimutuel sports system 100 and parimutuel sports system 100 updates an appropriate parimutuel pool with the bets. Continuing this example, player terminal 170c and player terminal 170n requested bets through wagering platform server 120 that total $30. The wagering platform server 120 requested bets be placed at parimutuel sports system 100 and parimutuel sports system 100 updates the appropriate parimutuel pool with the bets, which happens to be the same parimutuel pool for the bets from wagering platform server 130. If parimutuel sports system 100 determines that the payouts for the bets from player terminal 170c and player terminal 170n amount to $50 and the payouts for the bets from player terminal 170a and player terminal 170b also amount to $50, wagering platform server 120 is short $20 to payout the winning amounts to players at player terminal 170c and player terminal 170n. That is, the $50 payout amount exceeds the $30 value initially collected by wagering platform server 120 for the bet requests. On the other hand, wagering platform server 130 collected $20 more than it needs to payout for its bet requests. Since the bets from wagering platform server 120 were part of a parimutuel pool, the $20 should come from other participants in the parimutuel pool. In this case, the $20 should be provided by wagering platform server 130 to wagering platform server 120. Thus, in some implementations, wagering platform server 130 and/or parimutuel sports system 100 may redistribute funds collected at wagering platform server 130 for the bets from player terminal 170a and player terminal 170b to wagering platform server 120 to make wagering platform server 120 whole for participating in the parimutuel pool. As will be discussed further herein, another novel aspect of this parimutuel sports system is that parimutuel sports system 100 may enable new bets, such as parimutuel parlay bets that are at least partially player funded, which the wagering platform servers may be unable to offer on their own without the parimutuel sports system. In some implementations, a wagering platforms that participate in parimutuel pools may add funds to one or more parimutuel pools to seed the pool and increase the size of the pool. While the above net settlement process was described in the context of bets that are paid out parimutuelly, the net settlement process can also be applied to the modified fixed odds process. In some implementations, the net settlement process can also be used to determine apportionment of commissions or house-takes on bets or orders that are shared between the parimutuel sports system and one or more wagering platform servers. The net settlement process for commissions may occur after markets have resolved. However, to simplify how often the parimutuel sports system and the one or more wagering platform servers true up apportionment of commissions, the parties may periodically determine apportionment of commissions, such as every quarter, every six months, one a year or some other suitable time period.

Continuing with the illustration in FIG. 1B, in some implementations, parimutuel sports system 100 may calculate and deliver different parimutuel odds and different final odds for the same markets, depending on different factors. One factor may include the player's jurisdiction (e.g., a player betting from New Jersey may be presented with different final odds than a player betting from in Maryland). For example, a wagering platform server in New Jersey may be under a higher gaming tax than the wagering platform server in Maryland, which means the house-take for the bets may be higher in New Jersey than in Maryland to cover the taxes. If player terminal 170a is located in New Jersey with a house-take of 20% and player terminal 170c is located in Maryland with a house-take of 15%, and they wish to place bets on the same market with the same bet value (e.g., $10) through their respective wagering platform servers (e.g., wagering platform server 130 and wagering platform server 120), the final payout odds for the two bets placed with parimutuel sports system 100 will not be the same. While both bets might be placed with parimutuel sports system 100 at $10, the final payout odds for the bet placed through wagering platform server 130 will be based on $8 100 for player terminal player terminal 170a (due to the 20% house take), while the final payout odds for the bet placed through wagering platform server 120 will be based on $8.50 for player terminal 170c (due to the lower 15% house take). Thus, parimutuel sports system 100 can provide adjusted parimutuel odds and final odds to wagering platform server 130 and wagering platform server 120 to account for the differences in the house-take or other fees that may be culled from different players' bets.

FIG. 2 is a block diagram illustrating a parimutuel sports system 200, according to some implementations. Parimutuel sports system 200 in FIG. 2 is one possible representation of devices of a parimutuel sports system previously described, such as parimutuel sports system 100. The devices of parimutuel sports system 200 may include one or more computing platforms. The devices of parimutuel sports system 200 may be configured to communicate with one or more other devices according to a client/server architecture, a peer-to-peer architecture, and/or other suitable architectures. Users may interact with the parimutuel sports system 200 via certain devices, such as through player terminal and wagering platform servers, as discussed herein. In some implementations, the devices in parimutuel sports system 200 may include one or more processers, one or more electronic storage devices (e.g., non-transitory memory devices), and machine-readable instructions. In some implementations, electronic storage devices may include one or more databases.

The devices in parimutuel sports system 200 may include one or more of, but are not limited to, a market import system 210, a market selection system 220, a parimutuel market management system 230, a pricing system 240, and a pool total system 250, bet/order validation system 260, and/or other devices. The devices in parimutuel sports system 200 may be configured by machine-readable instructions. Machine-readable instructions may include one or more instruction modules. The instruction modules may include computer program modules.

In some implementations, the market import system 210 is configured to obtain available competitions such as, but not limited to American Football, Aussie Rules Football, Baseball, Basketball, Boxing, Cornhole, Cricket, Cycling, Darts, E-Sports, American Football, F1, Golf, Handball, Ice Hockey, Horse Racing, Dog Racing, Lacrosse, MMA (Mixed Martial Arts), Motor Sports, Rugby, Snooker, Soccer, Table Tennis, Tennis, Volleyball and any other competition from one or more wagering platform servers. In some implementations, the market import system 210 also obtains markets that are associated with the available competitions. The markets may include pre-game, in running, future, proposition, and other suitable markets. In some implementations, markets can be derived from one or more wagering platform servers. For example, an available competition at a wagering platform server can be an in-play singles tennis match, wherein markets may include available selections on the outcome of the next serve, outcome of the next game, etc. As another example, if an available competition at a wagering platform server is a horse race that hasn't started, markets may include typical markets for the horse race (e.g., win, place, show, etc.). In some implementations, market import system 210 may request that one or more wagering platform servers provide available competitions and markets associated with the available competitions. In some implementations, to obtain the available competitions and associated markets, the market import system 210 may establish a connection to a wagering platform server to obtain the competition and market information. In some implementations, the market import system 210 may communicate with wager platform servers via application programming interfaces (“APIs”) or using other suitable communications mechanisms. In some implementations, market import system 210 may request the competition and market information from the one or more wagering platform servers. In some implementations, the one or more wagering platform servers may push or broadcast the information to market import system 210. In some implementations, the market import system 210 may pull the information from the one or more wagering platform servers. In some implementations, the competition and associated market information can be obtained by market import system 210 using a combination of requests, pulls, broadcast, and/or pushes from one or more wagering platform servers. The market import system 210 may store information associated with available competitions and markets in one or more data storage locations. As a competition ends or as a market closes or resolves market import system 210 may remove competitions that ended and/or markets that closed or resolved from the one or more data storage locations. Market import system 210 may deliver available competitions and markets to the market selection system 220 by request or market import system 210 may push such information to the market selection system 220 when new markets open or previously open markets close/resolve. Parimutuel sports system 200 may include one or more running instances of a market import system 210.

In some implementations, a market selection system 220 is configured to perform functions such as obtaining markets from the market import system 210. The market selection system 220 may obtain the markets from market import system 210 by requests, pulls, broadcast, and/or pushes, or a suitable combination thereof. The market selection system 220 may evaluate markets to determine whether the markets adhere to one or more predetermined criteria for selection. The criteria may include, but is not limited to, the type of competition associated with the market, estimated duration of the market, market complexity, as well as other suitable criteria. The functions of market selection system 220 can enable the parimutuel sports system 200 to accurately place player bets on markets that are open at a wagering platform server and avoid attempting to place bets on markets that have closed or resolved or competitions that have ended. Market selection system 220 may evaluate markets received from market import system 210 to determine which of such markets are most likely to resolve within one or more periods of time (e.g., markets that will end in 10 seconds, markets that will end in 15 seconds, markets that will end within 30 seconds, markets that will end within 1 minute, etc.). It should be appreciated that much longer time frames may apply to pre-game or future markets. Market selection system 220 may analyze markets based on their associated estimated times the markets will close or resolve to sort and organize such markets for rapid sharing with other modules, such as parimutuel market management system 230. In some implementations, market selection system 220 may retain one or more markets that meet predetermined selection criteria in one or more data storage locations such as an electronic storage device. In some implementations, parimutuel sports system 200 may include one or more running instances of a market selection system 220.

In some implementations, a parimutuel market management system 230 is configured to manage parimutuel pools. Parimutuel market management system 230 may obtain markets from market import system 210 by requests, pulls, broadcast, and/or pushes, or a suitable combination thereof. Parimutuel market management system 230 may process requests to create new markets (including new parlay markets). For example, a player or operator may seek to create one or more new parlay markets for a competition, using existing markets for the competition, where such parlay markets do not exist. Parimutuel market management system 230 may review and determine whether to approve the creation of the markets. The parimutuel market management system 230 may evaluate markets to determine whether new parlay markets can be resolved based on existing markets that can be obtained from a wagering platform server (e.g., a wagering platform server). Parimutuel market management system 230 may manage parimutuel pools for new markets. Parimutuel market management system 230 may close parimutuel pools upon resolution or closing of the markets. Parimutuel market management system 230 may respond to requests from player terminals for available markets (including parlay markets). Parimutuel market management system 230 may publish information about markets to player terminals or to other suitable systems or devices. In some implementations, the published information may include updated parimutuel odds for a market or other suitable market information. Parimutuel market management system 230 may enable player terminals to request filtered market information in a number of suitable ways. For example, parimutuel market management system 230 may enable a player terminal to request certain markets selections for particular competitions. For example, a player terminal may seek markets that will open or close in the next 15 mins for tennis competitions. Parimutuel market management system 230 may filter the market and associated selections data as requested and provide the requesting player terminal (or wagering platform server) with appropriately filtered data. Parimutuel market management system 230 may return to requesting devices (e.g., wagering platform servers and/or player terminals) the information regarding the closing or resolution of a market. In some implementations, the parimutuel market management system 230 may provide requesting devices with market closing and resolution information by requests, pulls, broadcast, and/or pushes, or a suitable combination thereof. Parimutuel market management system 230 may receive, among other information, orders and requests for bets from one or more wagering platform servers and/or player terminals. Parimutuel market management system 230 may perform other suitable tasks for parimutuel sports system 200 as described herein. In some implementations, parimutuel sports system 200 may include one or more running instances of a parimutuel market management system 230.

In some implementations, a pricing system 240 is configured to, among other things, price bets/orders. The pricing system 240 may respond to requests to price bets/orders against the results of a market. For example, parimutuel market management system 230 may send a request to pricing system 240 to determine final odds for a resolved market. Pricing system 240 may be used to determine which selection or selections won in a parimutuel pool and determine the payout amounts for the winning bets/orders based on the size of the pool and final odds. Pricing system 240 may price bets/orders upon request, such as a request from parimutuel market management system 230. Pricing system 240 may price bets/orders based on market resolution information received from another system, such as a wagering platform server. For example, pricing system 240 may periodically request market resolution information from a wagering platform server. In some implementations, pricing system 240 may receive push notifications from a wagering platform server for market resolution information. Pricing system 240 may obtain market resolution information from appropriate sources by requests, pulls, broadcast, and/or pushes, or a suitable combination thereof. Pricing system 240 may send market resolution and payout information to player terminals and/or wagering platform servers. Pricing system 240 may send the market resolution and payout information to player terminals and/or wagering platform servers by requests, pulls, broadcast, and/or pushes, or a suitable combination thereof. Pricing system 240 may store the market resolution and payout information in a suitable database, such as an electronic storage system. In some implementations, parimutuel sports system 200 may include one or more running instances of a pricing system 240.

In some implementations, a pool total system 250 is configured to maintain parimutuel odds for selections for markets in the various available parimutuel pools. The pool total system 250 may respond to requests for parimutuel odds for one or more selections in one or more markets. For example, a player terminal may request parimutuel odds for one or more markets. Pool total system 250 may calculate parimutuel odds for the one or more markets and send the parimutuel odds to the player terminal and/or a wagering platform server. In some implementations, pool total system 250 may calculate parimutuel odds for selections on a gross pricing basis or a net pool pricing basis. In some implementations, the manner in which parimutuel odds are calculated may be dictated by a wagering source configuration. A wagering source may represent an individual wagering platform server. In some implementations, different wagering sources may also be associated with a single wagering platform server. For example, a wagering platform server may request to treat different bets differently (e.g., bets above a threshold may be placed in a different parimutuel pool than bets below the threshold—wherein the different parimutuel pools may have different parimutuel odds). For purposes of tracking, pool total system 250 may treat the same wagering platform server as a first wagering source for the bets above a threshold and as a different second wagering source for bets below the threshold. In some implementations, after a new market is approved for wagering (e.g., by parimutuel market management system 230), pool total system 250 may evaluate the new market against predetermined rules to determine which wagering sources are permitted to request bets on the new market and what the price configuration should be for the new market based on one or more attributes of the market/competition. Pool total system 250 may send the parimutuel odds information to one or more various systems by requests, pulls, broadcast, and/or pushes, or a suitable combination thereof. In some implementations, parimutuel sports system 200 may include one or more running instances of a pool total system 250.

In some implementations, a bet/order validation system 260 is configured to validate requests for bets and orders. The validation process may include analyzing requests for bets or orders to determine one or more aspects about the requests for bets or orders. For example, the validation may include determining whether a request for a bet is for a market that has closed or a market that has resolved. The bet/order validation system 260 may analyze other aspects of a request for a bet or an order to determine whether to accept or reject the request. The order validation system 260 may the placement status of the request for bets or orders to wagering platform servers, player terminals, and to the pool total system 250. The pool total system 250 may update an appropriate parimutuel pool if the request for a bet or an order is accepted and recalculate the parimutuel odds for the parimutuel pool. In some implementations, parimutuel sports system 200 may include one or more running instances of a bet/order validation system 260.

While certain features and functions of the market import system 210, market selection system 220, parimutuel market management system 230, pricing system 240, pool total system 250 and/or bet/order validation system 260 were described, it should be appreciated that the features and functions of these systems are not limited to descriptions provided herein. Furthermore, additional features and functions of the parimutuel sports system 200 and its devices are described in greater detail in this disclosure.

In some implementations, the devices in parimutuel sports system 200 may be operatively linked to other devices via one or more electronic communication links such as network 205. Network 205 may include the features and functions of the previously described networks, such as network 192. Electronic communication links may be established, at least in part, via a network such as the Internet and/or other networks. It will be appreciated that this is not intended to be limiting, and that the scope of this disclosure includes implementations in which devices in parimutuel sports system 200 may be operatively linked to other devices via some other communication systems. In some implementations, devices in parimutuel sports system 200 may be operatively linked to other parimutuel sports systems via suitable communication systems. By way of non-limiting example, a given parimutuel sports system 200 may comprise one or more servers and/or other suitable computing platforms.

Devices in parimutuel sports system 200 may include electronic storage, one or more processors, and/or other components. Devices in parimutuel sports system 200 may be in communication with separate electronic storage devices, such as network attached storage systems. Devices in parimutuel sports system 200 may include communication lines, or ports to enable the exchange of information with a network and/or other computing platforms. The illustration of parimutuel sports system 200 in FIG. 2 is not intended to be limiting. The devices in parimutuel sports system 200 may include a plurality of hardware, software, and/or firmware components operating together to provide the functionality attributed herein to parimutuel sports system 200. For example, parimutuel sports system 200 may be implemented using cloud computing systems and/or multiple platforms operating together as parimutuel sports system 200.

Electronic storage for devices in parimutuel sports system 200 may comprise non-volatile or non-transitory storage media that electronically stores information. The electronic storage media may include one or both of system storage that is provided integrally (i.e., substantially non-removable) with devices of parimutuel sports system 200 and/or removable storage that is removably connectable to devices of parimutuel sports system 200 via, for example, a port (e.g., a USB port, a firewire port, etc.) or a drive (e.g., a disk drive, etc.). Electronic storage may include one or more of optically readable storage media (e.g., optical disks, etc.), magnetically readable storage media (e.g., magnetic tape, magnetic hard drive, etc.), electrical charge-based storage media (e.g., EEPROM, RAM, etc.), solid-state storage media (e.g., flash drive, etc.), and/or other electronically readable storage media. Electronic storage may include one or more virtual storage resources (e.g., cloud storage, a virtual private network, and/or other virtual storage resources). Electronic storage may store software algorithms, information determined by processor(s), information received from devices in parimutuel sports system 200, information received from other devices (e.g., player terminals, electronic game machines, wagering platform servers, etc.), and/or other information that enables parimutuel sports system 200 to function as described herein.

Processor(s) in devices of parimutuel sports system 200 may be configured to provide information processing capabilities. As such, processor(s) may include one or more of a digital processor, an analog processor, a digital circuit designed to process information, an analog circuit designed to process information, a state machine, and/or other mechanisms for electronically processing information. In some implementations, processor(s) may include a single entity or a plurality of processing units. These processing units may be physically located within the same device, or processor(s) may represent processing functionality of a plurality of devices operating in coordination. Processor(s) may be configured to execute machine readable instructions in market import system 210, market selection system 220, parimutuel market management system 230, pricing system 240, pool total system 250, bet/order validation system 260, and/or other systems as well as various databases. Processor(s) may be configured to execute machine readable instructions for market import system 210, market selection system 220, parimutuel market management system 230, pricing system 240, pool total system 250, bet/order validation system 260, and/or other systems by software; hardware; firmware; some combination of software, hardware, and/or firmware; and/or other mechanisms for configuring processing capabilities of the processor(s).

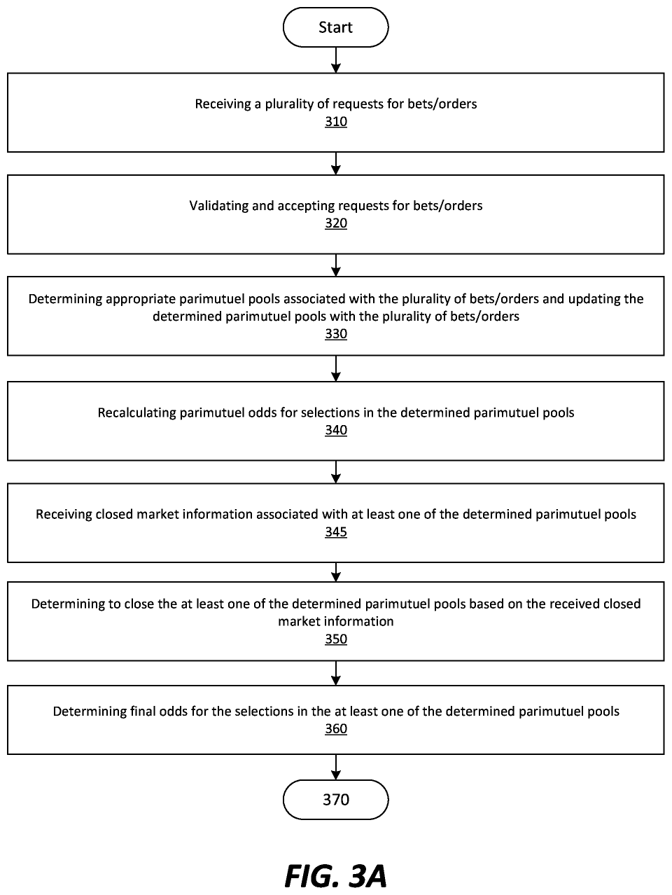

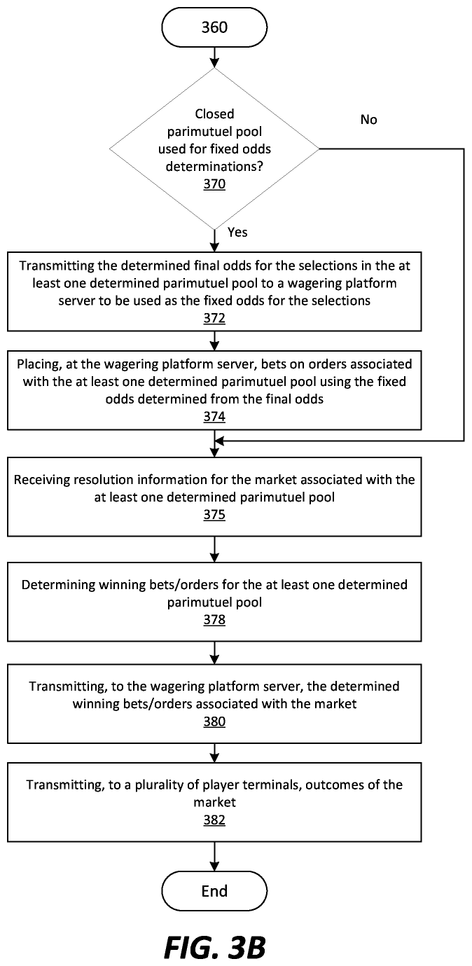

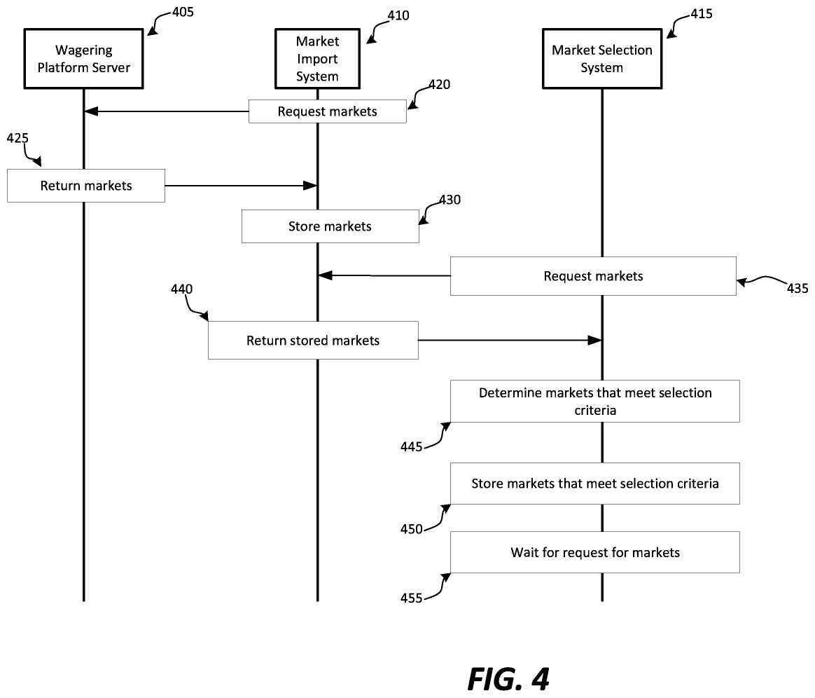

In some implementations, market import system 210, market selection system 220, parimutuel market management system 230, pricing system 240, pool total system 250, and bet/order validation system 260 may correspond to similarly named systems described in FIG. 3A, FIG. 3B, and FIG. 4-FIG. 9B. The description of the functionality provided by the different systems (e.g., market import system 210, market selection system 220, parimutuel market management system 230, pricing system 240, pool total system 250, and/or bet/order validation system 260) described herein is for illustrative purposes, and is not intended to be limiting. Any of market import system 210, market selection system 220, parimutuel market management system 230, pricing system 240, pool total system 250, and/or bet/order validation system 260 may provide more or less functionality than is described. For example, one or more of market import system 210, market selection system 220, parimutuel market management system 230, pricing system 240, pool total system 250, bet/order validation system 260 may be eliminated, and some or all of their functionality may be provided by other ones of such systems or eliminated.

FIGS. 3A and 3B are flowcharts that describes some methods of operating a gaming system such as parimutuel sports system 100 and parimutuel sports system 200 (or the various systems illustrated in FIG. 4-FIG. 9B), according to some implementations of a parimutuel sports system. As will be discussed herein, in some implementations, the novel parimutuel sport system enables sports betting using parimutuel payout determinations, and modified fixed odds payout determinations, and creation of new markets that may include custom parlay markets. It should be appreciated that the order of the processes illustrated in FIG. 3A and FIG. 3B are merely one possible implementation for a parimutuel sports system. In some implementations, the process illustrated in FIG. 3A and FIG. 3B may include more blocks or fewer blocks (e.g., more processes or fewer processes). In some implementations, the order of the blocks in FIG. 3A and FIG. 3B can be arranged in a different order than illustrated and described herein.

In some implementations, at 310, the method may include receiving a plurality of requests for bets/orders. The requests for bets/orders may be received from wagering platform servers or player terminals. For example, a bet/order validation system of the parimutuel sports system may receive requests for bets or requests for orders from one or more wagering platform servers. The requests for bets or requests for orders may be for pre-game, in running, future, and proposition markets. The requests for bets or requests for orders may be for parlay bets. A parlay bet (also known as an accumulator, combo bet, or multi bet) is a single bet that links together two or more individual selections on different markets. A simple parlay bet example is a first market of determining who will win a football game combined with a second market of determining the point spread for the football game in a single bet. A parlay bet may include the combined bets of (1) Team A wins the football game and (2) the point spread is 14+ for the football game. For a player to win the parlay bet, both bets must resolve as true. If one bet in the parlay bet resolves as not true, then the parlay bet is lost. That is, the parlay bet is won if Team A wins the football game and a winning team wins by at least 14 points. If Team B wins the football game, the parlay bet is lost regardless if Team B won by 14 points. The plurality of requests may be treated as requests for bets or requests for orders depending on how the payouts for the requests will be processed. For example, if the request will be paid out parimutuelly and determined by a parimutuel sports system, the requests can become placed bets at the parimutuel sports system. However, if the requests will be paid out using the modified fixed odds by a wagering platform server, the requests will be treated as orders at the parimutuel sports system and the duties of converting the orders into placed bets will be left to a wagering platform server.

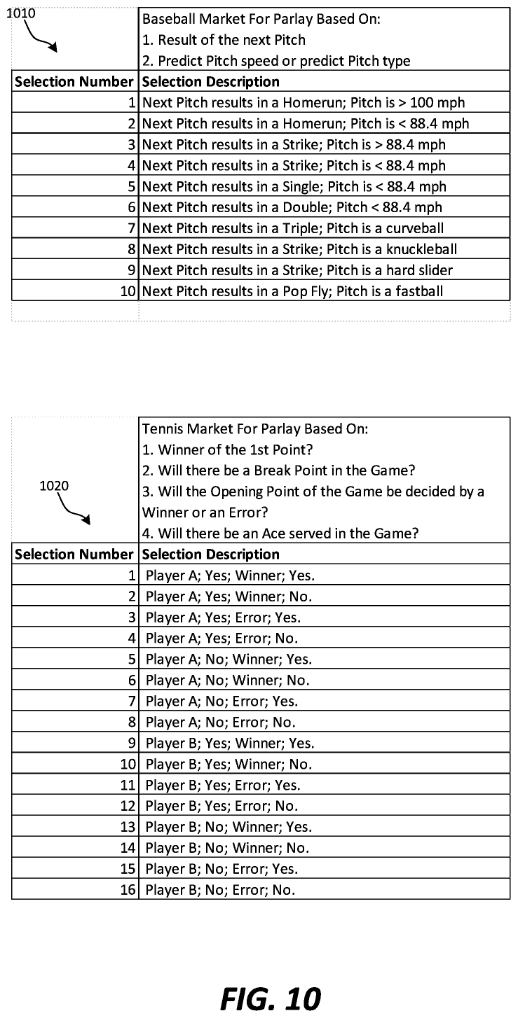

In some implementations, a parlay bet may include more than two individual bets on a plurality of different markets, such as shown in table 1020 in FIG. 10. In some implementations, the markets used for the parlay bet should exclude markets that may be subsets of each other and would be resolved together, rather than independently (e.g., the resolutions of markets in a parlay bet should be mutually exclusive). For example, an improper parlay bet for a baseball game may include (1) betting that the next pitch is an out and (2) that the same pitch is a strike out. That is, if the next pitch resolves are a strike out, then naturally that same pitch is also an out. These two markets are not mutually exclusive because they cannot be resolved independently of each other. On the other hand, a proper parlay bet for a baseball game may include (1) the next pitch results in a homerun and (2) the pitch is greater than 100 mph. If a pitch results in a homerun, it does not also mean that the pitch must be greater than 100 mph. Likewise, if the pitch is greater than 100 mph, it does not also mean the pitch will result in a homerun. While determining the resolution of both markets stems from the same pitch, one market being true, does not also make other market necessarily true. As noted in other figures, interlinked bets for parlay bets may be sent directly to a parimutuel sports bet server from player terminals or player terminals may route their interlinked bets through another system, such as a wagering platform server. A wagering platform server may include a sportsbook server, a totalizator, an advance deposit wagering server, or other systems that make markets and track market resolutions. While FIG. 3A and FIG. 3B illustrate individual selections, the method described in FIG. 3A and FIG. 3B can also be applied to interlinked selections too.

At 320, the method may include validating and accepting requests for bets/orders at a bet/order validation system or parimutuel sport system. For example, when an order is received at the bet/order validation system, the bet/order validation system may determine whether a market for the order is still open. The bet/order validation system may determine whether the wager value meets predetermined criteria, such as meeting a minimum wager value threshold. The bet/order validation system may analyze the order using other suitable criteria to determine whether the order is valid. If the bet/order validation system determines that the order is valid, the bet/order validation system may accept the order. If the bet/order validation system determines that the order is not valid, then the bet/order validation system may reject the order. The bet/order validation system may send notifications of the acceptance or rejection of the order to a wagering platform server or a player terminal (e.g., whichever device sent the order to the bet/order validation system). The bet/order validation system may also send a notification to a pool total system if the order is accepted.

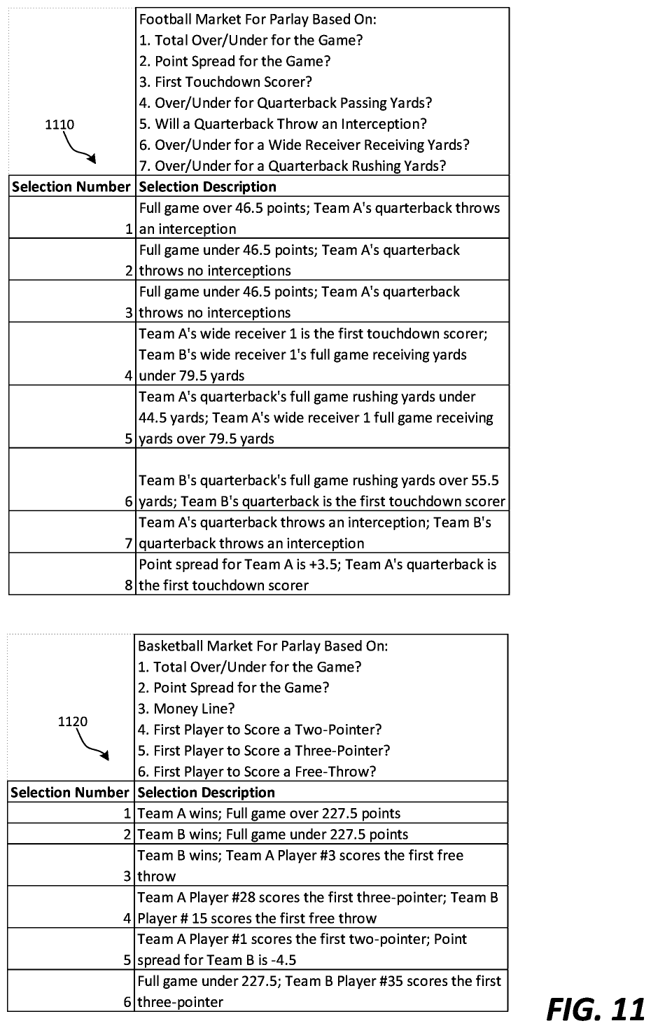

At 330, the method may include determining appropriate parimutuel pools associated with the plurality of accepted bets/orders and updating the determined parimutuel pools with the plurality of accepted bets/orders. For example, the pool total system of the parimutuel sports system may receive notification from the bet/order validation system that an order was accepted. The pool total system may determine the parimutuel pool that is associated with the order. If the order is related to an in running tennis match and the market is determining the winner of the next point, the pool total system may determine parimutuel pool for that market. Likewise, if the order is for a parlay bet for a baseball game the pool total system may determine parimutuel pool for that market. As an example, table 1010 in FIG. 10 illustrates a baseball market for a parlay bet. The table 1010 lists 10 selections for the market based on the result of the next pitch of an in running baseball game and predicting the pitch speed or predicting the pitch type. The selections in this table are part of a predetermined template of selections for a market that can be associated with a parimutuel pool. If the pool total system receives a bet or order with these selections for a particular competition, the parimutuel pool associated with this template can be updated based on the bet or order. That is, as shown at 330, the method may include updating the parimutuel pool based on the wagers value of the bet or order. If the pool total system receives an order for a parlay bet with selection other than the selections shown in table 1010, the pool total system may determine the appropriate parimutuel pool for the order (e.g., one or more parimutuel pools different from the parimutuel pool associated with table 1010). For example, if the selections in a parlay bet are associated with a football market template in table 1110 in FIG. 11, then the pool total system may update the parimutuel pool created for the table 1110 based on the parlay bet. Likewise, if the selections in a parlay bet are associated with a basketball market template in table 1120 in FIG. 11, then the pool total system may update the parimutuel pool created for table 1120 based on the parlay bet. While FIGS. 3A and 3B are discussed in terms of determining that bets or orders are associated with particular parimutuel pools, it should be appreciated that in practice, the parimutuel sport system may receive and process thousands or even millions of bets or orders daily. In such scenarios, the method described herein will determine the appropriate parimutuel pools for the received bets or orders.

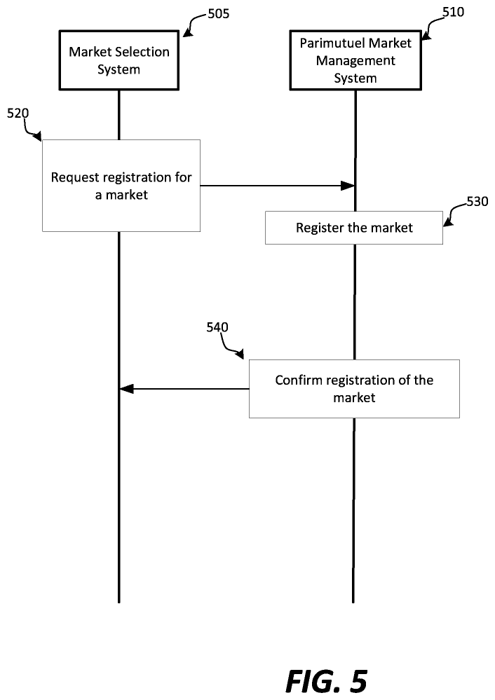

Returning to block 330, in some implementations, the determination process may examine other factors associated with the received bets or orders before determining the appropriate parimutuel pool for the bets or orders. As further described in connection with FIG. 1B and in FIG. 5, more than one parimutuel pool may be created for a market for a variety of different reasons. Separate parimutuel pools might be created for a market to segregate selections by wagering platform server (e.g., bets from wagering platform server 130 are placed into one parimutuel pool and bets from wagering platform server 120 are placed into a separate parimutuel pool), for particular jurisdictions (e.g., like bets from players in Virginia are grouped into one parimutuel pool for the market and like bets from players in Nevada are grouped into another parimutuel pool for the market), for a market where the payout will be determined using the fixed odds that are determined parimutuelly, etc. If other parimutuel pools are available for a market, block 330 may further include determining which of several parimutuel pools created for same bets or orders are proper before the bets or orders are associated with such parimutuel pools. In some implementations, as previously noted, orders for the same market can be associated with a single parimutuel pool, regardless of the jurisdiction where the order originated and not violate regulations that may restrict bets crossing jurisdictional borders. This is possible because in some implementations, orders are not converted into placed bets at the parimutuel sports system and the funds for wager values associated with orders do not cross state jurisdictional lines. Rather, orders can be converted to placed bets at originating wagering platform servers and funds for wager values remain with the originating wagering platform servers. This enables the parimutuel sports system to determine parimutuel payout odds from many more players that was previously possible across jurisdictions, and then pass back determined fixed odds based on the crowd sourced betting information to relevant wagering platform servers in different jurisdictions.

In some implementations, at 340, the method may include recalculating, at a pool total system, parimutuel odds for selections in the determined parimutuel pools based on wager values of the bets or orders. Because parimutuel odds for selections in parimutuel pools are based on the amount wagered, as parimutuel pools are updated based on new wager values from bets or orders, the parimutuel pools can be updated to reflect the additional wager values that are associated with the various selections for the parimutuel pools. For example, if a parimutuel pool to be updated is associated with the market of table 1010, the pool total system may recalculate the parimutuel odds for the selections in table 1010. The process in block 340 may be performed when the parimutuel pools are updated based on newly accepted bets or orders. The process in block 340 can be performed at predetermined intervals. The process in block 340 can be performed on demand, such as when a request for odds are received.

At 345, the method may include receiving closed market information associated with at least one of the determined parimutuel pools. For example, a wagering platform server may send market information to a market import system of the parimutuel sports system indicating that the market has closed. The market import system may send the market closing information to a market selection system, which sends the market closing information to a parimutuel market management system. In some implementations, market import system may send the market closing information directly to the parimutuel market management system. The market information provided by the wagering platform server may be real time or near real time information. As will be discussed further in FIG. 4, wagering platform servers and the parimutuel sports systems such as market import system and the market selection system communicate to keep competition and market information up to date.

At 350, the method may include determining, at a parimutuel market management system, to close the parimutuel pool. The determination to close the parimutuel pool may be based on the market closing information received at block 345. However, the determination can be made independently of information received by the parimutuel sports system.

At 360, the method may include determining, at a pricing system, final odds for the selections in the at least one determined parimutuel pools. For example, if table 1010 represents the selections for a parimutuel pool that has closed, the pricing system may analyze the total parimutuel pool value and the bets or orders made for the various selections in the parimutuel pool and calculate final odds for the 11 selection options in table 1010. In some implementations, the pricing system may also price the bets or orders made in the parimutuel pool. For example, in some implementations, the pricing system may determine the payout amount for bets or orders made on selection number 1 in table 1010 under the assumption that selection number 1 is the winning selection for the market. The pricing system may determine the payout amounts for some or all of the selections in table 1010.

At 370, the method may include determining whether the parimutuel pool will be used for fixed odds determination. If the parimutuel pool will not be used for fixed odds determinations, the process may proceed to block 375. If the parimutuel pool will be used for fixed odds determination, the process may proceed to block 372. At 372, the method may include transmitting the determined final odds for the selections in the at least one determined parimutuel pool to a wagering platform server to be used as the fixed odds for such selections. Continuing the example using table 1010, the pricing system may send the final odds for the 11 selections to the wagering platform server. In some implementations, the pricing system may also send the potential payout amounts for the bets or orders to the wagering platform server, if these calculations were made at block 360. By providing the potential payout amounts to the wagering platform server, the wagering platform server will have this payout data ready once the wagering platform server determines the winning selections or is provided the winning selections from the parimutuel sport system.

At 374, the method may include placing, at the wagering platform server, bets on orders associated with the at least one determined parimutuel pool using the fixed odds determined from the received final odds. In some implementations, once the wagering platform server obtains the final odds for the selections of a parimutuel pool, the wagering platform server uses these parimutuelly determined odds as fixed odds. For example, if the final odds for the selections in table 1010 are received at the wagering platform server, the wagering platform server may assign such final odds as fixed odds to the selections. The wagering platform server can then convert any orders into placed bets based on the supplied fixed odds from the parimutuel sports system. As should be appreciated, in some implementations, block 372 and block 374 may not occur for bets that will be paid out parimutuelly by the parimutuel sports system.

At 375, the method may include receiving resolution information for the market associated with the at least one determined parimutuel pool. For example, a wagering platform server may send market resolution information to a market import system of the parimutuel sports system. The market resolution information provided by the wagering platform server may be real time or near real time information. As will be discussed further in FIG. 4, wagering platform servers and the subsystems of the parimutuel sports systems such as market import system and the market selection system may communicate frequently to keep competition and market information up to date.

Using table 1010 in FIG. 10 as an example, the market was based on (1) Predicting the result of the next pitch and (2) Predicting the speed of the pitch speed or type of the pitch. A wagering platform server may provide the parimutuel market management system with the resolution information that the pitch was a strike, the pitch speed was greater than 88.4 mph, and the pitch was a fastball.

At 378, the method may include determining the winning bets or winning orders for the at least one determined parimutuel pool. Using table 1010 in FIG. 10 as an example, the market was based on (1) Predicting the result of the next pitch and (2) Predicting the speed of the pitch speed or type of the pitch. A wagering platform server may have provided market resolution information that the pitch was a strike, the pitch speed was greater than 88.4 mph, and the pitch was a fastball. The parimutuel market management system may take this resolution information and evaluate the bets or orders for the parimutuel pool associated with table 1010 to determine any winners. If bets or orders were made on selection number 3 in table 1010 for example, these bets or orders would be determined winners for the parimutuel pool. If there were no winners, the wager values in the parimutuel pool can be pushed or rolled to the next time the market is relevant. In some implementations, when wager values for a parimutuel pool are pushed or rolled, the wager values are moved to a new parimutuel pool for the next instance of a similar market. For example, in a baseball game, the market in table 1010 can be used again for the next pitch if there were no winners. In some implementations, the wager values from the parimutuel pool with no winners may be added to a parimutuel pool for the next pitch (e.g., the players from the parimutuel pool with no winners essentially place the same bets or orders on the next pitch without having to use new funds). If the market for the next pitch also results in no winners, the wager values in the parimutuel pool can be pushed or rolled again. In some implementations, wager values for players may be continually pushed or rolled to future next pitches until a winner for the market is determined. In some implementations, new player bets or orders on the market from table 1010 for the next pitches can be added to parimutuel pools that have pushed or rolled wager values to further increase the size of the parimutuel pools. In some implementations, if there were no winners, the host of the parimutuel pool may keep the money from the parimutuel pool. In some implementations, the host may keep the money from a parimutuel pool after the parimutuel pool is initially closed and no winner was determined. In some implementations, the host may keep the money from a parimutuel pool after the wager values for a parimutuel pool are pushed or rolled a predetermined number of times and no winners were determined. In some implementations, the money from a parimutuel pool may be returned or refunded to players after the wager values for a parimutuel pool are pushed or rolled a predetermined number of times or after some triggering event (such as the end of a competition) and no winners were determined.

In some implementations, where more than one wagering platform server provided bets or orders, the parimutuel market management system may determine appropriate settlements for relevant wagering platform servers. For example, if one wagering platform server is owed more funds than it received from bets or orders (e.g., due to payouts to its players exceeding the volume of funds it received from players), parimutuel market management system may facilitate shifting funds from one wagering platform server to another so that the payouts by the wagering platform servers do not shortchange a particular wagering platform server. This net settlement information can be provided to the relevant wager platform servers, such as when winning information is provided at block 380 or at some other suitable time.

At 380, the method may include transmitting, to the wagering platform server, the determined winning bets or orders associated with a market. For example, if selection number 3 in table 1010 was determined the winning selection for the market, bets or orders on selection number 3 would be identified as winning bets or orders in a message sent to the wagering platform server. In some implementations, the pricing server or the parimutuel market management system may transmit the winning bets or orders information to the wagering platform server. In some implementations, the winning bets or orders information may include pricing data for the winning bets or orders to the extent that this information was not already sent to the wagering platform server. For winning orders that are paid out using fixed odds, the wagering platform server may perform further processing on the on the winning selections to determine the payout amounts for the winning selections to the extent this information was not provided by the parimutuel sports system.

At 382, the method may include transmitting, to a plurality of player terminals, outcomes of the market. In some implementations, where player terminals placed bets or orders through a wagering platform server, the wagering platform server transmits the outcomes on the market including any winning payouts to the player terminals. In some implementations, a system, such as the parimutuel market management system or pricing system of the parimutuel sports system may transmit the outcome information on the market to the player terminals. When player terminals receive the outcome information on the market, the player terminals may display the outcome information including any winning payout information and the results of the player's bets. One of the wagering platform server or a system in the parimutuel sports system or the player terminals may update the player accounts with any payout information.

In some implementations, the competition may be an in running competition. As noted above, the bets or orders can be provided for markets that are pre-game, in running, future, proposition, or other suitable markets. For example, the selections for the market in table 1010 can be offered to players at any time during an in running baseball game. These selections can be provided one or more times (e.g., for different pitches in a baseball game) or for each pitch in a baseball game. It should be appreciated that the competition may be in the future. When the competition is in the future, the selections in a market may be different from the selections for a market that is offered while a competition is in running. For example, selections for the first player to score a three-pointer in a basketball game may not be offered as a future or pre-game market if the player line up remains unknown until the just before or when the competition starts (e.g., the injury status of one or more players will not be revealed until game time).

In some implementations, when the selections for a parimutuel pool are for a parlay market, the interlinked bets may be based on related markets. For example, table 1010 in FIG. 10 illustrates a selections for a parlay market based on related markets. That is, markets that are derived from the same next pitch in a baseball game. It should also be appreciated that parlay markets can be based on less related markets. An example of this is illustrated in table 1020 in FIG. 10, which shows combined tennis markets for one competition in a parlay market, but the markets will be resolved at different times during the competition. The parlay markets illustrated in table 1110 and 1120 of FIG. 11 are further examples of markets used for parlay markets that may happen at the beginning of a game and at the end of a game. Parlay market can also be based on unrelated markets from unrelated competitions. Parlay markets can be for markets that are pre-game or future markets. In some implementations, the longer parlay markets are open to receive new bets or orders (e.g., opening parlay market a day or more before a competition starts), the larger the parimutuel pool for the market may grow because it gives players more time to find the market and make the bets or orders. The larger the parimutuel pool grows, the more accurate the crowd sourced data may become when the final odds are used for determining fixed odds.

In some implementations, the markets may be selected for the parlay markets using at least one predetermined selection criteria for suitability of the markets. For example, a parimutuel sports system may not offer all available markets (including parlay bets) for a competition during the entire time a competition is in running. In some implementations, the markets may not occur due to the current state of the game. For example, if a tennis competition has progressed to the final game in a match that is 5-0, the first point is already decided for the game, and the player that is ahead is the favorite to win, the market for determining the opening point in a game may not resolve because there may not be additional opening points in future games of the match. In such situations, the parimutuel sports system may evaluate the markets that can be resolved before offering such markets to players.

While the forgoing methods described a small scale of processing bets and orders, it should be appreciated that the parimutuel sports system may support millions of similar transactions a day. A further breakdown of how different systems within a parimutuel sports system can operate in some implementations is described in connection with FIG. 4-FIG. 9B below.

FIG. 4 illustrates communications and processes between different devices and/or systems of a parimutuel sports system for managing markets according to some implementations of the present disclosure. FIG. 4 relates to a subsystem that obtains markets associated with available competitions from one or more wagering platform servers (e.g., sportsbook servers, advance deposit wagering systems, totalizators, etc.), organizes the markets, and provides the markets to other subsystems of a parimutuel sport betting system. In some implementations, the devices and systems discussed in FIG. 4 correspond to the devices and systems discussed in other sections of the present disclosure. For example, the market selection system 415 corresponds to the market selection system 220, market selection system 505, and the market selection system 908. It should be appreciated that the order of the process illustrated in FIG. 4 is merely one possible implementation. In some implementations, the process illustrated in FIG. 4 may include more blocks or fewer blocks (e.g., more processes or fewer processes). In some implementations, the order of the blocks in FIG. 4 can be arranged in a different order than illustrated and described herein. In some implementations, the process illustrated in FIG. 4 may use more systems or fewer systems than illustrated to accomplish the same functions.

As shown at 420, to obtain the latest available competitions and markets, market import system 410 may send a request for markets to wagering platform server 405. Markets may include markets for competitions that are pre-game, in running/live, future, proposition, as well as other suitable markets. Market import system 410 may periodically make the request at 420 to wagering platform server 405 to keep its records of available competitions and markets up-to-date. Market import system 410 may obtain market information from wagering platform server 405 using requests, pulls, broadcasts, pushes, or some suitable combination of the foregoing. In some implementations, market import system 410 may communicate with one or more wagering platforms to obtain a larger variety of markets. In such situations, block 420 may include sending requests to plurality of wagering platforms.

In some implementations, as shown at 425, wagering platform server 405 may transmit or return markets to market import system 410. In some implementations, the markets sent to market import system 410 may include associated information such as market description (e.g., for a competition that is a baseball game, a market description may include predicting the outcome of the next pitch), minimum and maximum wager values, odds, whether the market is associated with an in running/live competition, and/or other suitable information. In some implementations, the information sent to market import system 410 may include other information such as how long before the markets resolve or close (e.g., how soon the outcome of the next pitch will be determined). In some implementations, as shown at 430, market import system 410 may store markets and associated information. In some implementations, market import system 410 may perform further processing on the stored markets, such as removing markets that are no longer open (e.g., markets that have closed or resolved).

As shown at 435, market selection system 415 may request stored markets from market import system 410. This request at 435 can be made at any time. The request at 435 can be made periodically to keep the market data as current as reasonably necessary. Market selection system 415 may make the request at 435 when it receives a request from a parimutuel market management system for suitable markets. As shown at 440, market import system 410 may return stored markets to the market selection system 415. In some implementations, market import system 410 may push market information to market selection system 415 without market selection system 415 making a request for market information.

In some implementations, market selection system 415 may process the markets received from market import system 410 to make the data more usable for other systems in the parimutuel sports system. For example, as shown at 445, market selection system 415 may determine whether the provided markets meet predetermined criteria. The criteria may include whether the provided markets are likely to resolve by one or more different times. The criteria may include, but is not limited to, the type of competition (tennis, basketball, football, horse racing, etc.), type of markets (who wins next point, which team makes next basket, etc.), types of selections available for the markets, the quantity of selections available for the markets, whether the market is likely to occur given the state of a competition, whether the competition is pre-game or in running, etc. This enables the market selection system 415 to have usable data ready to send to a system such as the parimutuel market management system and reduce potential delays, rather than waiting to perform the processing at 445 upon a request from another system. In some implementations, selecting markets that meet particular criteria also enables market selection system to eliminate markets or particular aspects of markets that might not translate well from a fixed-odds sports betting system to a parimutuel sports system. In some implementations, market selection system 415 may perform the process at 445 when market selection system 415 receives new market data from market import system 410.

While not shown in FIG. 4, market selection system 415 may receive requests to create custom parlay markets (e.g., for interlinked bets) using two or more markets from competitions, as was previously described. The custom parlay markets and their associated selections can be stored as templates. A custom parlay market and its selections can be associated with a parimutuel pool. When players place bets or orders on a custom parlay market, the bets or orders become interlinked bets that can be received by a parimutuel sports system. The interlinked bets for a same custom parlay market can be grouped into the same parimutuel pool for determining payouts. It should be appreciated that the custom parlay markets are based on markets provided by wagering platform servers, but the custom parlay markets are markets that may not be offered by wagering platform servers independent of the parimutuel sports system. One reason for this is that determining odds for parlay markets is difficult and a host of a wagering platform server may not be able to reasonably determine odds for the custom parlay markets. However, by using the crowd sourced nature of the parimutuel sports system to determine odds, the parimutuel sports system can create and offer new markets like custom parlay markets that could not be offered by wagering platform servers without the parimutuel sports system.

Requests for the custom parlay markets can be from an operator (e.g., operator of a parimutuel sports system or a wagering platform), may come from players at player terminals, or from another system of the parimutuel market management system. The market selection system 415 may obtain one or more selections for the custom parlay market. Examples of some possible selections for custom parlay markets are illustrated in the tables in FIG. 10 and FIG. 11. While four small examples are shown in FIG. 10 and FIG. 11, any suitable markets and selections can be used to create custom parlay markets. The market selection system 415 may determine one or more selections from information sources such as a wagering platform server or other network connected information sources that can provide outcome resolutions for the markets in the custom parlay markets. In some implementations, if selections are not provided or the market selection system 415 cannot obtain possible selections for the requested custom parlay market, the market selection system 415 may reject the request to create a custom parlay market. For example, in some implementations, if finite selections are not provided for a market, it may not be possible to determine parimutuel odds for the market. The market selection system 415 may reject a request to create a custom parlay market for other reasons. For example, if market selection system 415 determines that a reliable source of market resolution data cannot be found (e.g., providing reliable data that indicates that the market is resolved and how the market resolved—that is, which selection for a market becomes the winning selection), the market selection system 415 may reject creation of the custom parlay market. While the process to handle requests to create custom parlay markets is discussed as being handled by the market selection system 415, it should be appreciated that other systems may handle this process, such as the parimutuel market management system. Moreover, as will be described in connection with FIG. 5, the parimutuel market management system includes a process to register new markets (which may include custom parlay markets created from markets supplied by a wagering platform server). In some implementations, once new markets are registered, players can submit requests for bets or orders on the new markets. Alternatively, in some implementations, once new markets are accepted by market selection system 415, players can submit requests for bets or orders on such new markets without going through registration.

In some implementations, as shown at 450, market selection system 415 may store markets that meet the predetermined criteria. In some implementations, market selection system 415 may also organize the markets, wherein the process of organizing the markets may employ any one of a number of different suitable data management techniques. In some implementations, as shown at 455, market selection system 415 may wait for a request for markets (including custom parlay markets), such as from the parimutuel market management system. In some implementations, market selection system 415 may periodically remove markets (e.g., including custom parlay markets based on the same markets) that have closed or resolved so that these markets or custom parlay markets are not sent to other systems, such as a parimutuel market management system. In some implementations, when markets are provided for in running competitions, processing data in real time or near real time about markets is important to avoid offering unavailable markets. Removing markets also reduces the amount of data to store and to process, making the parimutuel sports system more efficient. It should be appreciated that the market import system 410 and the market selection system 415 may store the market data in a database or other suitable data storage system. It should be appreciated that the subsystem in FIG. 4 can be one part of the process of providing a parimutuel sports system and may work in tandem with other systems and subsystems discussed herein.

FIG. 5 illustrates communications and processes between different devices and/or systems of a parimutuel sports system for creating new markets (including new custom parlay markets) that can be offered to players in the parimutuel sports system according to some implementations of the present disclosure. FIG. 5 relates to a subsystem that registers new markets for parimutuel pools. In some implementations, the devices and systems discussed in FIG. 5 correspond to the devices and systems discussed in other sections of the present disclosure. It should be appreciated that the order of the process illustrated in FIG. 5 is merely one possible implementation. In some implementations, the process illustrated in FIG. 5 may include more blocks or fewer blocks (e.g., more processes or fewer processes). In some implementations, the order of the blocks in FIG. 5 can be arranged in a different order than illustrated and described herein. In some implementations, the process illustrated in FIG. 5 may use more systems or fewer systems than illustrated to accomplish the same functions. It should be appreciated that the subsystem in FIG. 5 can be one part of the process of providing a parimutuel sports system and may work in tandem with other systems and subsystems discussed herein.

As shown at 520, market selection system 505 may request registration for one or more markets (including one or more custom parlay markets). As discussed in connection with FIG. 4, market selection system 505 may have new markets obtained from one or more wagering platforms or from requests to create custom parlay markets. In some implementations, parimutuel market management system 510 does not make such new markets available to players for wagering until parimutuel market management system 510 has registered the new market. For purposes of FIG. 5, registering a market may include registering a custom parlay market.

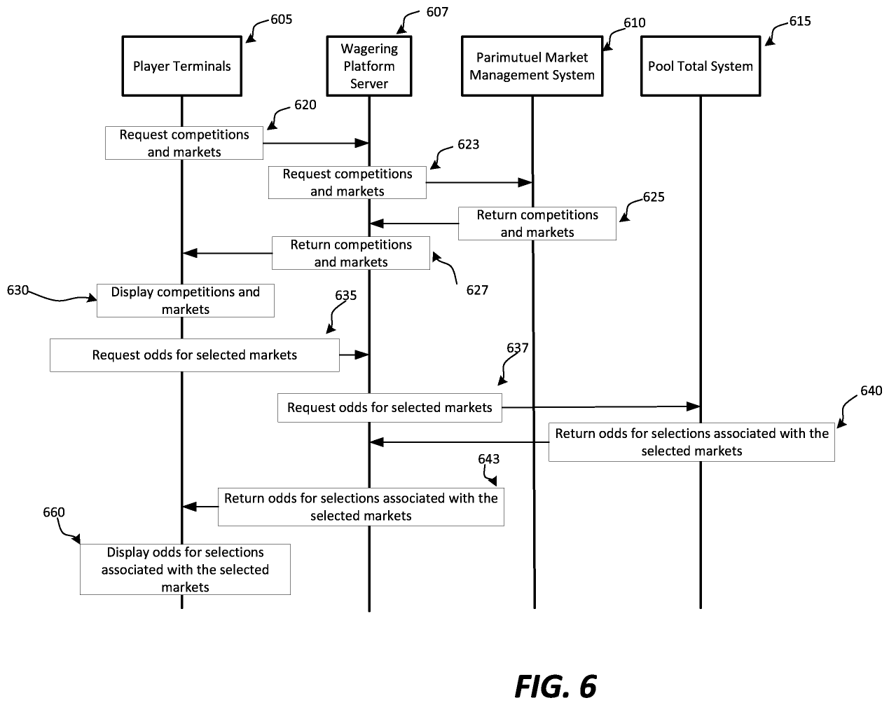

As shown at 530, parimutuel market management system 510 may register the market. The registration process may include storing the market in a database for later retrieval. The registration may include storing relevant information about the market, such as available selections for the market that a player can select for their bet or order. The market may be stored as a template of available selections, such as the selections shown in table 1010 in FIG. 10. In some implementations, the registration enables parimutuel market management system 510 to offer the stored market to players as a potential market to bet on, as will be described in connection with FIG. 6. In some implementations, parimutuel market management system 510 may perform additional analysis on the market to determine whether the market should be registered. For example, parimutuel market management system 510 may review existing registered markets for the same market as the market provided at block 520. If the same market is found, parimutuel market management system 510 may refuse the registration and provide an indication to the market selection system 505 that the market already exists. In some implementations, where the market is a custom parlay market, market selection system 505 may provide a message to a system requesting the custom parlay market that the same market already exists. The market selection system 505 may provide a link to the already existing market so that the requestor can review the existing market. The same or similar markets may be grouped together as discussed below in connection with 535.

Parimutuel market management system 510 may associate the registered market with a parimutuel pool. However, parimutuel pools may not be created until bets or orders are received for a registered market. Parimutuel market management system 510 may create a new parimutuel pool for the market. The parimutuel pool for the market may ensure that bets or orders for the market are properly grouped so that appropriate parimutuel odds can be determined for selections in the market and an appropriate payouts can be determined for the winning bet(s). In some implementations, the parimutuel market management system 510 may search for existing parimutuel pools for the market. If an existing parimutuel pool for another market exists, but the market is similar to the existing market (e.g., the selections are the same or similar), parimutuel market management system 510 may associate the market with the existing parimutuel pool. This scenario may arise where custom parlay markets are worded differently, but are substantially similar and the selections for the custom parlay markets are substantially similar—enabling parimutuel market management system 510 to group the new market and the existing market with the same parimutuel pool. Thus, players making bets or orders on the different markets will be grouped together for purposes of parimutuel odds determinations, which also helps to increase the size of the parimutuel pools for the similar markets.

In some implementations, registering a market may be associated with creating a plurality of parimutuel pools for the market. In some implementations, gaming regulations may dictate that bets cannot cross state lines, thus, separate new parimutuel pools may be created for the market in one or more jurisdictions where the market will be offered to players. For example, if the market will be offered in New Jersey and in Nevada, the parimutuel market management system 510 may create one parimutuel pool for New Jersey and one parimutuel pool for Nevada for the same market. When bets or orders are received for the market from New Jersey, such bets or orders are placed with the parimutuel pool for New Jersey for the market. Likewise, when bets or orders are received for the market from Nevada, such bets or orders are placed with the parimutuel pool for Nevada for the market. In some implementations, separate pools for the same market can be created per operator, per wagering platform server, or for some other suitable reason. In some implementations, a parimutuel pool for a market can be created for received bets or orders from one or more jurisdictions (e.g., one or more states; one or more nations). In some implementations, when bets or orders are received, the bets or orders can be examined using geolocation or geofencing to determine which parimutuel pool for the market can be used with the bet or order.

As shown at 540, parimutuel market management system 510 may confirm registration of the market. In some implementations, parimutuel market management system 510 may also confirm the creation of the parimutuel pool for the market or the addition of the market to an existing parimutuel pool.

In some implementations, when a new parimutuel pool is created, the house or host of the parimutuel pool may provide initial funding or seeding for the parimutuel pool or provide a minimum payout guarantee. This enables player bets for the parimutuel pool to be paid out with some suitable minimum payout even if a quantity or values of player bets into the parimutuel pool does not reach a desired level of initial funding or reach the value of the minimum payout guarantee. In some implementations, the initial seeding may be provided by one or more operators wagering platform servers that send requests for bets to the parimutuel sports system.

FIG. 6 illustrates communications and processes between different devices and/or systems of a parimutuel sports system for providing player terminals with access to market information according to some implementations of the present disclosure. FIG. 6 relates to a subsystem that provides competitions and associated markets to wagering platform servers and player terminals so players can choose their selections, including custom parlay bets. In some implementations, the devices and systems discussed in FIG. 6 correspond to the devices and systems discussed in other sections of the present disclosure. It should be appreciated that the order of the process illustrated in FIG. 6 is merely one possible implementation. In some implementations, the process illustrated in FIG. 6 may include more blocks or fewer blocks (e.g., more processes or fewer processes). In some implementations, the order of the blocks in FIG. 6 can be arranged in a different order than illustrated and described herein. In some implementations, the process illustrated in FIG. 6 may use more systems or fewer systems than illustrated to accomplish the same functions. It should be appreciated that the subsystem in FIG. 6 can be one part of the process of providing a parimutuel sports system and may work in tandem with other systems and subsystems discussed herein.

As shown at 620, player terminals 605 may request to view available competitions and markets for parimutuel wagering. Player terminals 605 may send the request to a wagering platform server 607. As previously discussed, different player terminals may communicate with more than one wagering platform servers 607, thus, wagering platform servers 607 may represent one or more wagering platform servers. In some implementations, player terminals 605 may send the request to parimutuel market management system 610 and bypass the wagering platform server 607. At 623, the wagering platform server 607 may send the requests for competitions and markets received from player terminals 605 to parimutuel market management system 610. In some implementations, parimutuel market management system 610 may communicate with wagering platform servers 607 and player terminals such as player terminals 605 and provide information on competitions and markets (including custom parlay markets) using requests, pulls, broadcasts, pushes, or some suitable combination of the foregoing. In some implementations, player terminals 605 may enable the player to request particular market and competition data. For purposes of FIG. 6, a mention of a market or markets includes custom parlay markets. For example, player terminals 605 may permit the player to narrow the competitions that are retrieved from parimutuel market management system 610 to one or more competitions (e.g., the player can request competitions and markets for tennis matches and/or baseball games). In some implementations, the player can provide player terminals 605 with suitable filters to the competition and market information so that parimutuel market management system 610 provides the player with information that the player wanted and not information on competitions that the player has no interest in. For example, the player may restrict the request to particular competitions and request markets that may resolve in the next 30 minutes. As another example, the player may not restrict the request to a particular competition, but may seek to view markets that are custom parlay markets. In some implementations, player terminals 605 may request all available competition data and all market data without restrictions or any suitable variation.

As shown at 625, a parimutuel market management system 610 may return available competitions and markets for parimutuel wagering to the wagering platform server 607. As shown at 627, wagering platform server 607 may return available competitions and markets for parimutuel wagering to the player terminals 605. As noted above, parimutuel market management system 610 may select and return the competition and market data that was specified in the request at 620. In some implementations, parimutuel market management system 610 may provide all available competition and market data. In some implementations, parimutuel market management system 610 may provide a suitable subset of competition and market data, and the blocks at 620, 623, 625, and 627 can repeat to provide new or updated lists of competition and market data on demand or at periodical intervals. In some implementations, parimutuel market management system 610 obtains and returns market data based on real time or near real time market data. If a player is seeking information on an in running competition, the parimutuel market management system 610 may limit the markets provided to wagering platform server 607 and player terminals 605 based on markets that may still resolve in the in running competition. This may include parimutuel market management system 610 requesting updated market and competition data from the market selection system of FIG. 4. Using the custom parlay market template in table 1010 in FIG. 10 as an example, parimutuel market management system 610 or the market selection system may analyze the selections or the individual markets that form the custom parlay market to determine if these markets or the selections can be resolved based on the state of the baseball competition. Since the markets and selections in table 1010 should occur if there is a next at bat, this template should be permitted to be offered at most times during an in running baseball game and before a baseball game starts. If the table 1010 included a market that resolves during the second inning of a baseball game, and the parimutuel market management system 610 determines that the baseball game is already in the 5^{th} inning, then that market or template for the market would no longer be relevant and may not be provided to wagering platform server 607 and player terminals 605 as a response to a request for competitions or markets.

As shown at 630, player terminals 605 may display the competitions and markets obtained from wagering platform server 607 to a player. After reviewing provided markets, as shown at 635, player terminals 605 may request odds for markets. In some implementations, player terminals 605 may request odds for certain selected markets. It should be appreciated that restricting the request for odds to a small and relevant set of markets reduces the communications and processing burdens on pool total system 615 and the player terminals 605. In some implementations, player terminals 605 may request some other suitable subset odds for markets or all odds for markets. In some implementations, the request at 635 is sent to wagering platform server 607. At 637, wagering platform server 607 may send the request for odds to pool total system 615. In some implementations, wagering platform server 607 may send the request for odds to parimutuel market management system 610, with parimutuel market management system 610 acting as an interface or proxy to the parimutuel sports system to outside systems such as wagering platform server 607 and player terminals.

As shown at 640, a pool total system 615 may return odds for selections associated with the selected markets to the wagering platform server 607. At 643, the wagering platform server 607 may return odds for selections associated with the selected markets to player terminals 605. In some implementations, pool total system 615 may periodically provide odds for the selections associated with the selected markets to wagering platform server 607, whether or not requested (which can be forwarded to player terminals 605). As shown at 660, player terminals 605 may display the odds for the selections associated with the selected markets obtained from the pool total system 615 to a player.

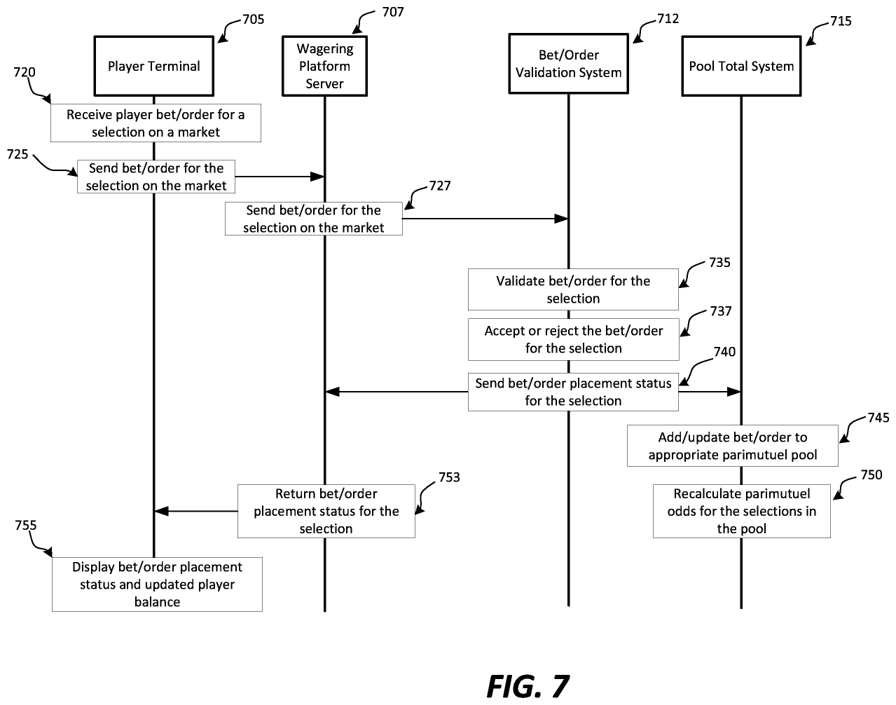

FIG. 7 illustrates communications and processes between different devices and/or systems of a parimutuel sports system for submitting requests for bets or orders on markets (including custom parlay markets) according to some implementations of the present disclosure. In some implementations, the devices and systems discussed in FIG. 7 correspond to the devices and systems discussed in other sections of the present disclosure. It should be appreciated that the order of the process illustrated in FIG. 7 is merely one possible implementation. In some implementations, the process illustrated in FIG. 7 may include more blocks or fewer blocks (e.g., more processes or fewer processes). In some implementations, the order of the blocks in FIG. 7 can be arranged in a different order than illustrated and described herein. In some implementations, the process illustrated in FIG. 7 may use more systems or fewer systems than illustrated to accomplish the same functions. It should be appreciated that the subsystem in FIG. 7 can be one part of the process of providing a parimutuel sports system and may work in tandem with other systems and subsystems discussed herein.

As shown at 720, the player terminal 705 may receive a request for a bet or order for a selection (e.g., one of a plurality of selections for a market—such as selection number 5 from table 1010 in FIG. 10) on a market from a player. In some implementations, if the player is betting on a custom parlay market, the request for a bet or order may include a plurality of selections for the custom parlay market. For example, if the player requests a bet on the custom parlay market example shown in table 1010 in FIG. 10, the player may make a selection for the first market (e.g., the next pitch results in a double) and make another selection for the second market (e.g., the pitch was less than 88.4 mph). As another example, if the player requests an order on the custom parlay market example shown in table 1110 in FIG. 11, the player may be provided a choice to choose two markets and their associated selections from a plurality of markets in a template in which to build a parlay bet order for a particular parimutuel pool. While the table 1110 shows building a two market custom parlay market, the player can be offered the ability to build a custom parlay bet using more markets. Offering the player choices provides the player with control over the custom parlay bets the player can build. The player may also be provided a plurality of selections for the chosen two markets for the custom parlay market. In some implementations, markets may have more selections than can be reasonably offered to players. In some implementations, the parimutuel sports system offers all selections that are available for market. In some implementations, the parimutuel sports system offers fewer than all selections that are available for market. For example, take the market of the first player to score a three-pointer in table 1120 in FIG. 11. In the case of table 1120, every player on Team A or Team B might be a possible selection option for the market of the first player to score a three-pointer, especially if the starting lineup for the game is not known at the time selections are made for this market. This increases the choices available to a player and may make it confusing for a player to make a selection for a bet or an order. As shown in table 1120, the template for the basketball market may offer fewer than all selections available for the markets in the custom parlay market.

Returning to 720, the request for a bet or order for a selection on a market may also include the player's wager value. It should be appreciated that player terminal 705 may receive any number of requests for bets or orders from a player.

As shown at 725, player terminal 705 may send the request for a bet or order for the selection on the market to a wagering platform server 707. As noted previously, if the payout for the request for a bet or order will be processed using fixed odds, wagering platform server 707 may treat the request as an order until fixed odds have been determined for the order. As an order, the wagering platform server 707 may hold the funds for wager value associated with the order and funds may not be passed to the parimutuel sports system. At 727, the wagering platform server 707 may send the request for a bet or order for the selection on the market to bet/order validation system 712. The wagering platform server 707 may retain the funds received regardless of whether the payout for the request for a bet or an order will be processed using fixed odds at the wagering platform server 707 or processed parimutuelly using one or more components of the parimutuel sports system. In some implementations, wagering platform server 707 may transmit the funds received for the request for a bet or an order to bet/order validation system 712 when one or more components of the parimutuel sports system handles payout distribution.

As shown at 735, bet/order validation system 712 may process the request for a bet or order for the selection. In particular, the bet/order validation system 712 may perform validation on the request for a bet or order. As noted above, the validation may include determining whether a bet or order could be placed on the market. That may include determining whether the market is still open or whether the market has closed or resolved. If the market identified in the request for a bet or order has closed or has resolved, the bet/order validation system 712 may determine that the request for a bet or order is not valid. As shown at 737, the bet/order validation system 712 may accept or reject the request for the bet or order depending on the outcome of the validation process in block 735. As shown at 740, bet/order validation system 712 may send a placement status of the request for a bet or order to wagering platform server 707 and to pool total system 715. In some implementations, the placement status of a request for a bet or order is only sent to pool total system 715 if the request for a bet or order is accepted. If the order validation system 712 accepts the request for a bet, the request for a bet is considered a placed bet.

When pool total system 715 receives the notice of the placement status for a bet or order for a selection, the pool total system 715 may determine the appropriate parimutuel pool for the bet or order and update the appropriate parimutuel pool based on the bet or order. The update may include incrementing the parimutuel pool total and the total for the selection based on the wager value of the bet or order. For example, if the bet or order for the selection was for a selection number 8 of the custom parlay market in table 1010, then pool total system 715 may add the wager value for the bet or order to the total for selection number 8 and increment the parimutuel pool total created for the custom parlay bet in table 1010. In some implementations, where the bet or order for the selection is for a market that was already registered, the process may proceed to block 745. However, in some implementations, if the bet was for a new custom parlay market, the pool total system 715 may consider the custom parlay market a new market that requires a separate parimutuel pool. In some implementations, pool total system 715 may run the process described in FIG. 5 to register the custom parlay market as a new market to be registered. A parimutuel market management system may thereafter offer the custom parlay market to other players to create a viable parimutuel pool. In some implementations, if a threshold quantity and/or value of bets are not placed into the parimutuel pool for a market, pool total system 715 may cancel the bets or orders and remove the market so that the market is no longer available for player bets or orders. It should be appreciated adding or updating the appropriate parimutuel pool with a wager value may not include adding the actual funds of the bet or order for the selection to the parimutuel pool. As previously noted, the parimutuel sports system may not physically control the funds for the wager value in some implementations because the funds may be stored and remain at wagering platform server 707. Thus, adding or updating the wager value for an appropriate parimutuel pool may comprise tracking the wager value for the bet or order for the selection at the parimutuel pool.

As shown at 750, pool total system 715 may recalculate the parimutuel odds for the selections in the market for the parimutuel pool. As the parimutuel pool is updated based on the bets or orders, the parimutuel odds will change for the selections. The parimutuel odds may continue to change as the parimutuel pool is updated with wagers values from other bets or orders until the parimutuel pool is closed. In some implementations, the updated parimutuel odds for the selection is sent to the wagering platform server 707. The wagering platform server 707 may send the updated parimutuel odds for the selection to the player terminal 705. In some implementations, parimutuel odds presented to the player may be based on the wager value less a commission (e.g., a commission taken by the host of the parimutuel sports system or the wagering platform server 707) and any taxes (e.g., for net pool pricing).

As shown at 753, wagering platform server 707 may return the bet or order placement status for selection to the player terminal 705. The wagering platform server 707 may also provide the player terminal 705 with the parimutuel odds for the selection. In some implementations, upon receiving the notice at block 740, the wagering platform server 707 may update the player account according to whether the bet or order was accepted or rejected. If the bet or order was accepted the player's account may reflect a decrease based on the wager value for the bet or order. If the bet or order was rejected the player's account may reflect an increase based on the wager value due to a refund. It should be appreciated, that in some implementations, as noted above, player funds for a bet or order may have already been removed from the player's account and escrowed at the time the player made a request for a bet or order. As shown at 755, player terminal 705 may display to the player the bet or order placement status and the updated player balance in accordance with the bet or order's wager value.

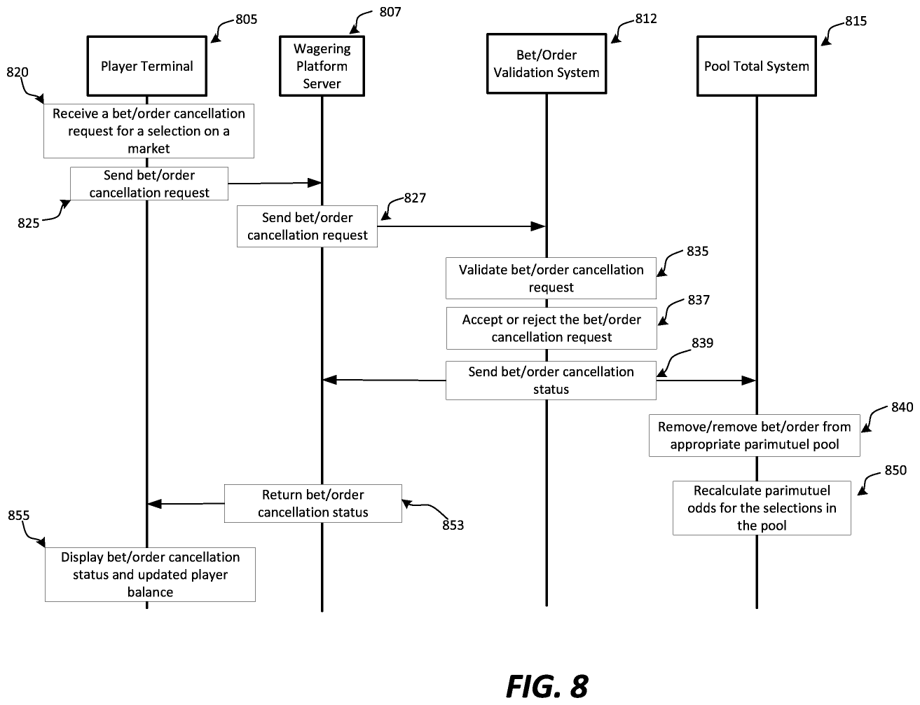

FIG. 8 illustrates communications and processes between different devices and/or systems of a parimutuel sports system for cancelling bets or orders for selections on markets according to some implementations of the present disclosure. In some implementations, the devices and systems discussed in FIG. 8 correspond to the devices and systems discussed in other sections of the present disclosure. It should be appreciated that the order of the process illustrated in FIG. 8 is merely one possible implementation. In some implementations, the process illustrated in FIG. 8 may include more blocks or fewer blocks (e.g., more processes or fewer processes). In some implementations, the order of the blocks in FIG. 8 can be arranged in a different order than illustrated and described herein. In some implementations, the process illustrated in FIG. 8 may use more systems or fewer systems than illustrated to accomplish the same functions. It should be appreciated that the subsystem in FIG. 8 can be one part of the process of providing a parimutuel sports system and may work in tandem with other systems and subsystems discussed herein.

As shown at 820, the player terminal 805 may receive a bet or order cancellation request for a selection on a previously placed bet or order from a player. It should be appreciated that player terminal 805 may receive any number of bet or order cancellations requests from a player.

As shown at 825, player terminal 805 may send the bet or order cancellation request to a wagering platform server 807. As shown at 827, wagering platform server 807 may send the bet or order cancellation request to a bet/order validation system 812.

As shown at 835, bet/order validation system 812 may process the bet or order cancellation request. The processing may include validating the bet or order cancellation request. For example, if bet/order validation system 812 received an order cancellation request, the bet/order validation system 812 may confirm that the order was accepted and that a parimutuel pool was updated based on the order. If the order cannot be found, the bet/order validation system 812 may determine that order cancellation request is not valid. If the order can be found, the bet/order validation system 812 may determine that the order cancellation request is valid. Another verification process that may be performed is determining whether the market associated with the order is closed or has already been resolved. In some implementations, cancellations for a bet or order may not be permitted once an associated market has closed or resolved. Other suitable verification steps can be taken to determine whether a bet or order cancellation request is valid. As shown in block 837, the bet/order validation system 812 may determine to accept or reject the bet or order cancellation request based on the validation process of block 835. If a bet or order cancellation request is deemed invalid, the bet/order validation system 812 may reject the bet or order cancellation request. If a bet or order cancellation request is deemed valid, the bet/order validation system 812 may accept the bet or order cancellation request. As shown at 839, the bet/order validation system 812 may send the bet or order cancellation status to wagering platform server 807 and the pool total system 815. In some implementations, bet/order validation system 812 only sends the bet or order cancellation status to the pool total system 815 if the bet or order cancellation status is accepted.

When pool total system 815 receives the notice of the cancellation status for a bet or order for a selection, the pool total system 815 may determine the appropriate parimutuel pool for the canceled bet or order and update the appropriate parimutuel pool based on the cancelled status of the bet or order as shown at 840. The update may include decrementing the parimutuel pool total and the total for the selection based on the wager value of the cancelled bet or order. In some implementations, the pool total system 815 may prevent the cancellation where the market had already resolved and/or the parimutuel pool had already closed if this was missed during the validation at block 835.

As shown at 850, pool total system 815 may recalculate the parimutuel odds for the selections the parimutuel pool in accordance with the wager value that was removed for the particular cancelled bet or order. As wager values are removed from a parimutuel pool, the parimutuel odds will change for the available selections for the parimutuel pool.

As shown at 853, the wagering platform server 807 may return the bet or order cancellation status to the player terminal 805. In some implementations, upon receiving the notice at block 840, the wagering platform server 807 may update the player's account according to whether the bet or order cancellation request was accepted or rejected. If the bet or order cancellation request was accepted, the player's account may reflect an increase based on the wager value for the bet or order that is refunded to the player. If the bet or order cancellation request was rejected, the player's account may reflect no change because no refund was issued. As such, the wagering platform server 807 may also return the information showing the player's updated account as necessary to the player terminal 805. As shown at 855, player terminal 805 may display to the player the bet or order cancellation status and the updated player balance in accordance with the returned wager value, if applicable.

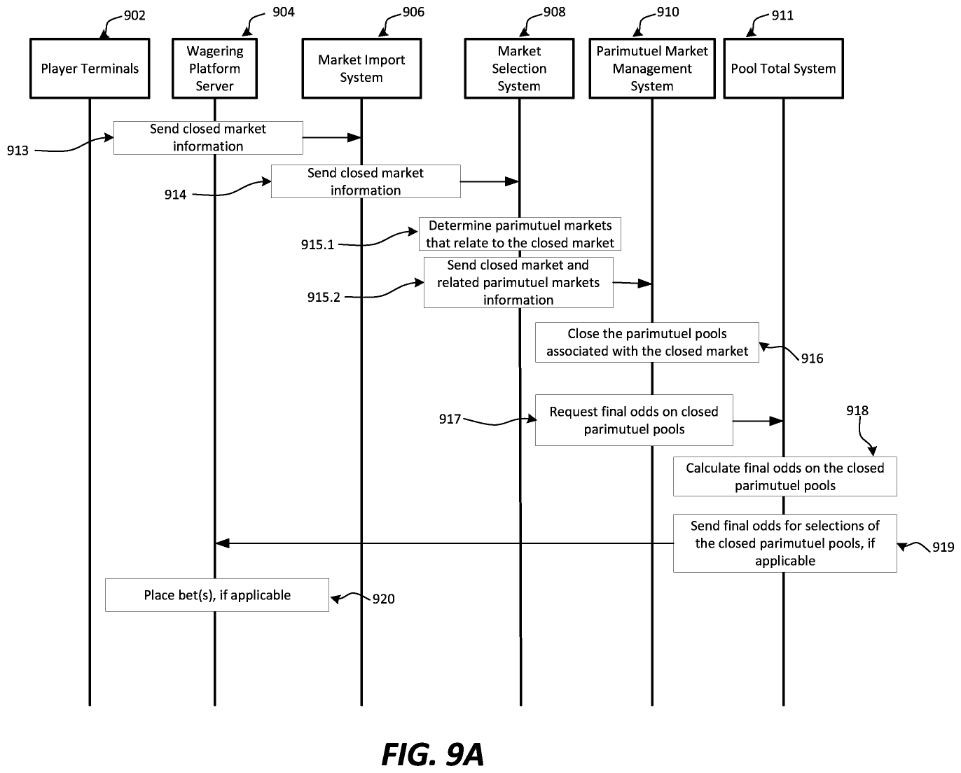

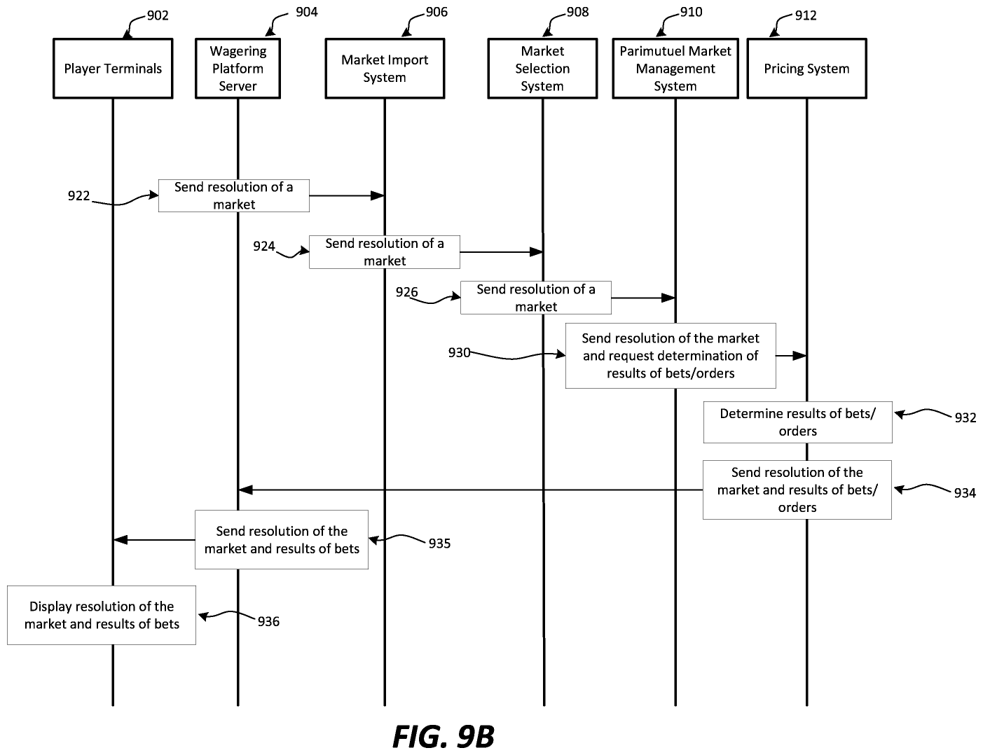

FIG. 9A illustrates communications and processes between different devices and/or systems of a parimutuel sports system for closing parimutuel pools according to some implementations of the present disclosure. In some implementations, the devices and systems discussed in FIG. 9A correspond to the devices and systems discussed in other sections of the present disclosure. It should be appreciated that the order of the process illustrated in FIG. 9A is merely one possible implementation. In some implementations, the process illustrated in FIG. 9A may include more blocks or fewer blocks (e.g., more processes or fewer processes). In some implementations, the order of the blocks in FIG. 9A can be arranged in a different order than illustrated and described herein. In some implementations, the process illustrated in FIG. 9A may use more systems or fewer systems than illustrated to accomplish the same functions. It should be appreciated that the subsystem in FIG. 9A can be one part of the process of providing a parimutuel sports system and may work in tandem with other systems and subsystems discussed herein.

Wagering platform server 904 may determine that a market should be closed. For example, wagering platform server 904 may determine that a pitcher is about to throw a pitch or a pitch clock is about to start. It should be appreciated that wagering platform server 904 may also continuously monitor a plurality of competitions and their related markets for triggers to close markets. Wagering platform server 904 may continuously send large volumes of market information to the parimutuel sports system. For example, as shown at 913, wagering platform server 904 may send closed market information to market import system 906. It should be appreciated that wagering platform server 904 may communicate the closed market information to market import system 906 by requests, pulls, broadcast, and/or pushes, or a suitable combination thereof.

As shown at 914, market import system 906 may send the closed market information to market selection system 908. As shown at 915, market selection system 908 may send the closed market information to parimutuel market management system 910. FIG. 4 provides a more thorough discussion of how wagering platform server 904, market import system 906, and market selection system 908 communicate and maintain up-to-date information on competitions and their markets.

As shown at 915.1, the market selection system 908 may determine parimutuel markets that relate to the closed market. In some implementations, the parimutuel sports system may have markets and associated parimutuel pools that match one for one with the closed market. For example, if the closed market information indicated that a market for predicting the winner of the 1^{st} point of a tennis competition is closed, parimutuel sports system may have the same individual market with an associated parimutuel pool. However, as previously discussed, the parimutuel sports system also include custom parlay markets. These custom parlay markets might be partially based on individual markets that have closed. For example, the parimutuel sports system may offer a market such as the market in table 1020, where one of the individual markets in the parlay market is predicting the winner of the 1^{st} point of a tennis competition. Thus, market selection system 908 may need to review and find one or more parimutuel markets that are related to the closed market. After market selection system 908 determines parimutuel markets that relate to the closed market, the market selection system 908 may send the closed market and determined related parimutuel market information to parimutuel market management system 910.

As shown at 916, upon receiving the closed market information from market selection system 908, the parimutuel market management system 910 may determine to close the parimutuel pools associated with the closed market to avoid receiving new bets or orders for parimutuel pools that use closed market. While parimutuel market management system 910 may determine to close the parimutuel pools based on receiving closed market information from wagering platform server 904, parimutuel market management system 910 may determine to close the parimutuel pool using other triggers. For example, parimutuel market management system 910 may have been aware of when the pitch clock would start and initiated its own countdown timer to align with the pitch clock start. As the timer at parimutuel market management system 910 wound down, parimutuel market management system 910 may have determined on its own to close the parimutuel pool. In alternative implementations, parimutuel market management system 910 may rely on other external or internal triggering events to determine when to close a parimutuel pool.

As shown at 917, after closing the parimutuel pools associated with the closed market, parimutuel market management system 910 may send a request to determine final odds for selections in the closed parimutuel pools. As shown at 918, pool total system 911 may calculate final odds for one or more selections in the closed parimutuel pools. In some implementations, pool total system 911 may also price the closed parimutuel pools. That is, in some implementations, pool total system 911 may calculate possible payouts for bets or orders made in the closed parimutuel pools made by players based on the player's wager values and the final odds determined for the selections associated with the bets or orders. In some implementations, this pricing calculation may be performed at a later time, such as when the market has resolved, as shown in 932 in FIG. 9B. If the pricing calculations are made, the calculations can be stored and used once parimutuel market management system 910 or the pricing system 912 determine winning selections, as will be discussed in FIG. 9B.

As shown at 919, pool total system 911 may transmit the final odds for the closed parimutuel pools to wagering platform server 904. Pool total system 911 may perform 919, if parimutuel market management system 910 or pool total system 911 determine that the payouts for the orders in the parimutuel pool should be determined using fixed odds (e.g., the player requested an order). The determined final odds may be sent to wagering platform server 904 for orders, because wagering platform server 904 will use the final odds to determine fixed odds selections of a market and convert the orders into placed bets. This decision process is shown at 370 in FIG. 3B. In some implementations, if the payouts for the bets in the parimutuel pool will be determined parimutuelly at the parimutuel sports system, pool total system 911 may not send the final odds information to wagering platform server 904. However, in some implementations, pool total system 911 may send the final odds information for the closed parimutuel pools to wagering platform server 904 regardless of whether the payouts for the bets or orders will be determined using fixed odds or parimutuelly.

As shown at 920, in some implementations, wagering platform server 904 may place one or more bets based on receiving the final odds information for closed parimutuel pools from pool total system 911. As was previously discussed, if orders were received at wagering platform server 904 and the payouts for such orders are to be determined using fixed odds derived from a parimutuel pool, the orders may not have been converted into bets. The wagering platform server 904 may hold the orders until wagering platform server 904 receives final odds from pool total system 911 that wagering platform server 904 can use as its fixed odds before converting the orders into placed bets. Upon determining the fixed odds for orders, the wagering platform server 904 may place bets based on the orders.

FIG. 9B illustrates communications and processes between different devices and/or systems of a parimutuel sports system for resolving markets and determining payouts for bets or orders according to some implementations of the present disclosure. In some implementations, the devices and systems discussed in FIG. 9B correspond to the devices and systems discussed in FIG. 9A and in other sections of the present disclosure. It should be appreciated that the order of the process illustrated in FIG. 9B is merely one possible implementation. In some implementations, the process illustrated in FIG. 9B may include more blocks or fewer blocks (e.g., more processes or fewer processes). In some implementations, the order of the blocks in FIG. 9B can be arranged in a different order than illustrated and described herein. In some implementations, the process illustrated in FIG. 9B may use more systems or fewer systems than illustrated to accomplish the same functions. It should be appreciated that the subsystem in FIG. 9B can be one part of the process of providing a parimutuel sports system and may work in tandem with other systems and subsystems discussed herein.

Wagering platform server 904 may determine the outcome of a market to resolve the market. For example, if the market was determining whether tennis Team A or tennis Team B will win the next game, wagering platform server 904 may determine that tennis Team B won the next game to resolve the market. Wagering platform server 904 may determine the resolution of many markets at any given time. As another example, wagering platform server 904 may determine the resolutions of the markets in tables 1010 and 1020 in FIG. 10 or in tables 1110 and 1120 in FIG. 11.

As shown at 922, wagering platform server 904 may send the resolution of the market to market import system 906. For example, wagering platform server 904 may send to market import system 906 that tennis Team B won the next game for the market. In some implementations, wagering platform server 904 may communicate the resolution of the market to market import system 906 by requests, pulls, broadcast, and/or pushes, or a suitable combination thereof.

As shown at 924, market import system 906 may send the resolution of the market to market selection system 908. As shown at 926, market selection system 908 may send the resolution of the market to parimutuel market management system 910. In some implementations, wagering platform server 904 may communicate the resolution of markets to parimutuel market management system 910 without sending the resolution information through market import system 906 and/or market selection system 908. In some implementations, parimutuel market management system 910 may initiate requests for the market resolution information from wagering platform server 904 so that wagering platform server 904 knows what market resolution information to send to parimutuel market management system 910. It should be appreciated that block 920—block 926 may not occur for markets that are not provided by wagering platform server 904. For example, if wagering platform server 904 does not have market resolution information for a custom parlay market, parimutuel market management system 910 or other systems in the parimutuel sports system (e.g., market import system 906, market selection system 908, pricing system 912, or another suitable system) may need to seek alternative information sources to determine whether a market has closed or resolved and to determine the resolution of the market.

As shown at 930, parimutuel market management system 910 may send the resolution of the market to the pricing system 912. The parimutuel market management system 910 may also request that the pricing system 912 determining the results of the bets or orders. The parimutuel market management system 910 may also request that the pricing system 912 price the bets or orders for parimutuel pool associated with the market (e.g., if this was not already done, as shown in FIG. 9A).

As shown at 932, pricing system 912 may determine the results of the bets or orders for the parimutuel pool associated with the market. This may include determining winning bets or orders. Pricing system 912 may also price the winning bets or orders for the parimutuel pool to determine the payouts for the winning bets or orders. The pricing system 912 may determine payouts for the winning bets or orders for the parimutuel pool using parimutuel calculation techniques such as gross pricing or net pool pricing. For winning bets or orders that will be paid out by wagering platform server 904 using fixed odds, the wagering platform server 904 may handle additional processing of payouts for player bets. In some implementations, wagering platform server 904 may determine winning bets based on the received market resolution information and may calculate payouts for winning bets based on the fixed odds received from the parimutuel sports system.

As shown at 934, pricing system 912 may send resolution of the market information and results of bets or orders to the wagering platform server 904. The pricing system 912 may also send the payouts information for winning bets or orders for the parimutuel pool associated with the market to wagering platform server 904. As shown at 935, wagering platform server 904 may send the resolution of the market information and results of bets, which may include identification of the winning bets and the payouts for the winning bet to player terminal 902. As shown at 936, player terminal 902 may display the resolution of the market information and results of bets. The player terminal 902 may also display an update of the player's balance based on the payouts, as applicable (e.g., if the player's bet was a winning bet). It should be appreciated that the balance may be maintained by the wagering platform server 904 in some implementations. In alternative implementations, some systems of the parimutuel sports system may maintain and update the player's balance and provide this information to wagering platform server 904 or to the player terminal 902.

It should be appreciated that the improved parimutuel sports system disclosed herein provides a new type of game experience for players that was not previously been available in jurisdictions that allowed parimutuel wagering, but prohibited traditional fixed odds sports betting. In some implementations, the improved parimutuel sports system enables players to place familiar sports bets, but also enables novel, parlay bets that were not previously available in parimutuel wagering systems or in fixed odds wagering systems. The improved parimutuel sport system also provides a new way for hosts of wagering platform servers to determine fixed odds for all types of markets, including complex parlay markets (for which it was previously difficult to determine associated odds). It should also be appreciated that the foregoing disclosure provides technical solutions to the technical problems outlined above.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations have been described. Various modifications may be made without departing from the spirit and scope of the description. For example, various forms of the flow charts shown above may be used, with steps re-ordered, added, or removed. Accordingly, other implementations are within the scope of the following claims.

What is claimed:

1. A method of operating a gaming system, comprising:
receiving a plurality of orders, wherein different orders of the plurality of orders are made by different players;
determining to accept the plurality of orders based on a validation process;
determining parimutuel pools associated with the plurality of orders;
updating the parimutuel pools based on the plurality of orders;
recalculating parimutuel odds for sets of selections for the parimutuel pools based on the plurality of orders;
closing at least one parimutuel pool of the parimutuel pools to new orders;
determining final odds for a set of selections for the at least one parimutuel pool;
determining whether the at least one parimutuel pool will be paid out parimutuelly or using fixed odds;
transmitting fixed odds to a wagering platform server when the at least one parimutuel pool will be paid out using fixed odds, wherein the fixed odds are determined based on the determined final odds;
determining results of a market for at least one parimutuel pool;
determining winning orders for the at least one parimutuel pool based on the determined results of the market for the at least one parimutuel pool; and
transmitting, to the wagering platform server, outcomes based on the results of the market for the at least one parimutuel pool.

2. The method of operating the gaming system of claim 1, further comprising determining equal payout amounts for at least two orders of the plurality of orders, wherein the at least two orders are for a same market, the at least two orders are associated with a same wager value, the at least two orders are sent from a wagering platform server, and the at least two orders originated from a same state.

3. The method of operating the gaming system of claim 1, further comprising determining different payout amounts for at least two orders of the plurality of orders, wherein the at least two orders are for a same market, the at least two orders are associated with a same wager value, and the at least two orders are sent from different wagering platform servers.

4. The method of operating the gaming system of claim 1, further comprising determining different payout amounts for at least two orders of the plurality of orders, wherein the at least two orders are for a same market, the at least two orders are associated with a same wager value, and the at least two orders originated from different states.

5. The method of operating the gaming system of claim 1, wherein at least two orders of the plurality of orders are associated with one parimutuel pool of the determined parimutuel pools, wherein the at least two orders of the plurality of orders originated from different states, and wherein funds for wager values and bets resulting from the at least two orders are kept with respective wagering platform servers that sent the at least two orders.

6. The method of operating the gaming system of claim 1, wherein the determined final odds for the set of selections for the at least one parimutuel pool are based on orders that originate from a plurality of different states, wherein the determined final odds are calculated independent of receiving funds for wager values and bets resulting from orders for the at least one parimutuel pool.

7. The method of operating the gaming system of claim 1, wherein the at least one parimutuel pool is started with an initial seed value that is not derived from orders.

8. The method of operating the gaming system of claim 1, further comprising:
determining that another parimutuel pool of the parimutuel pools contains no winning orders; and
submitting new orders for a new market, wherein at least some wager values for orders from the another parimutuel pool that contained no winning orders are added to a new parimutuel pool for the new market.

9. The method of operating the gaming system of claim 8, further comprising:
returning funds associated with orders from the another parimutuel pool based on determining that new parimutuel pool for the new market contained no winning order.

10. The method of operating the gaming system of claim 1, wherein at least one of the orders from the plurality of orders is for an in running market.

11. The method of operating the gaming system of claim 1, wherein at least one of the orders from the plurality of orders is for a market comprising any one of: a pre-game market, a future market, and a proposition market.

12. The method of operating the gaming system of claim 1, wherein at least one of the plurality of orders is for a custom parlay market.

13. The method of operating the gaming system of claim 12, wherein available selections for the custom parlay market are based on a template of predetermined selections that players use to request orders for the custom parlay market.

14. The method of operating the gaming system of claim 1, further comprising determining available templates of predetermined selections for custom parlay markets to offer players based on real time market data on an in running competition.

15. The method of operating the gaming system of claim 14, further comprising excluding at least one template of predetermined selections for a custom parlay market from being offered to players for an in running competition based on determining that at least one selection in the at least one template is not available for the in running competition from the real time market data.

16. The method of operating the gaming system of claim 1, wherein transmitting the fixed odds to the wagering platform server causes the orders for at least parimutuel pool to be placed as fixed odds bets at the at least one wagering platform server using the transmitted fixed odds.

17. The method of operating the gaming system of claim 1, further comprising receiving closed market information from the wagering platform server.

18. The method of operating the gaming system of claim 17, further comprising closing a plurality of parimutuel pools based on receiving closed market information for one market, wherein the plurality of parimutuel pools comprise markets that include the one market.

19. A parimutuel system comprising:
receive, from a wagering platform server, a plurality of orders at bet/order validation system, wherein different orders of the plurality of orders are made by different players;
determine, at the bet/order validation system, to accept the plurality of orders based on a validation process;
determine, at a pool total system, parimutuel pools associated with the plurality or orders;
update, at the pool total system, the parimutuel pools based on the plurality of orders;
recalculate, at the pool total system, parimutuel odds for sets of selections for the parimutuel pools based on the plurality of orders;
close, using a parimutuel market management system, at least one parimutuel pool of the parimutuel pools to new orders;
determine, at the pool total system, final odds for the sets of selections for the at least one parimutuel pool;
determine, at the pool total system, whether the at least one parimutuel pool will be paid out parimutuelly or using fixed odds;
transmit, from the pool total system to the wagering platform server, fixed odds when the at least one parimutuel pool will be paid out using fixed odds, wherein the fixed odds are determined based on the determined final odds;
receive, at a pricing system, results of a market for the at least one parimutuel pool;
determine, at the pricing system, winning orders for the at least one parimutuel pool based on the results of the market for the at least one parimutuel pool; and
transmitting, from the pricing system to the wagering platform server, outcomes based on the results of the market for the at least one parimutuel pool.

20. A method of operating a gaming system, comprising:
receiving a plurality of requests for bets for parlay markets;
determining to accept the plurality of requests for bets based on a validation process, wherein the plurality of requests for bets become a plurality of bets;
determining parimutuel pools associated with the plurality of bets;
updating the parimutuel pools based on the plurality of bets;
recalculating parimutuel odds for sets of selections for the parimutuel pools based on the plurality of bets, wherein the selections in the sets of selections are based on at least two markets;
closing at least one parimutuel pool of the parimutuel pools to new bets;
determining final odds for a set of selections for the at least one parimutuel pool;
determining results of a parlay market for at least one parimutuel pool;
determining winning bets for the at least one parimutuel pool based on the determined results of the parlay market for the at least one parimutuel pool; and
transmitting, to a wagering platform server, outcomes based on the results of the parlay market for the at least one parimutuel pool.
